(19) United States
(12) Patent Application Publication
(10) Pub. No.: US 2019/0055337 A1
(43) Pub. Date: Feb. 21, 2019

(54) LOW-COST SYNTHESIS OF MACROMONOMERS

(71) Applicant: University of Tennessee Research Foundation, Knoxville, TN (US)

(72) Inventors: Jimmy W. Mays, Marco Island, FL (US); Nam-Goo Kang, Knoxville, TN (US); Weiyu Wang, Knoxville, TN (US); Huiqun Wang, Knoxville, TN (US)

(21) Appl. No.: 16/077,319

(22) PCT Filed: Feb. 2, 2017
(86) PCT No.: PCT/US17/16236

§ 371 Date: Aug. 10, 2018

Related U.S. Application Data
(60) Provisional application No. 62/290,299, filed on Feb. 2, 2016.

(51) Int. Cl. C08F 290/12; C08F 12/08; C08F 257/02; C09J 151/00

(52) U.S. Cl. CPC C08F 290/124; C09J 151/003; C08F 257/02; C08F 12/08

(57) ABSTRACT

Methods of preparing macromonomers, e.g., single- or double-tailed macromonomers, using radical polymerization of a first monomer in solution or in an emulsion are described. Methods of using the macromonomers in the preparation of multigraft copolymers are also described. For instance, the macromonomer prepared by radical polymerization can be used in an emulsion copolymerization with a second monomer to form a random multigraft copolymer. The random multigraft co-polymers can be superelastomers.

### RELATED APPLICATIONS

The presently disclosed subject matter claims the benefit of U.S. Provisional Patent Application Ser. No. 62/290,299, filed Feb. 2, 2016; the disclosure of which is incorporated herein by reference in its entirety.

### TECHNICAL FIELD

Methods of preparing single- and multi-tailed macromonomers, including double-tailed macromonomers, via radical polymerization are described. The radical polymerization can be performed in an emulsion. Methods of using the macromonomers in the preparation of multigraft copolymers are also described.

### BACKGROUND

Graft copolymers have attracted attention in many fields over the past few decades. See Hadjichristidis et al., Graft Copolymers, in Encyclopedia of Polymer Science and Technology, ed. A. Seidel, John Wiley & Sons, Hoboken, N.J., 2004, Vol. 6, page 348; and Cowie, Block and Graft Copolymers, in Comprehensive Polymer Science, ed., G. Allen and J. C. Bevington, Pergamon, Oxford, 1989, Vol. 3, p. 33. Compared to block copolymers, multigraft copolymers can provide additional architectural flexibility, since graft (side chain) density, graft length, and backbone length can be systematically varied. See Hadjichristidis et al., Graft Copolymers, in Encyclopedia of Polymer Science and Technology, ed. A. Seidel, John Wiley & Sons, Hoboken, N.J., 2004, Vol. 6, page 348; Cowie, Block and Graft Copolymers, in Comprehensive Polymer Science, ed., G. Allen and J. C. Bevington, Pergamon, Oxford, 1989, Vol. 3, p. 33; Hadjichristidis et al., Prog. Polym. Sci., 2006, 31, 1068; and Goodwin et al., Graft and Comblike Polymers, in Anionic Polymerization: Principles, Practice, Strength, Consequences, and Applications, ed., N. Hadjichristidis and H. Hirao, Springer, Berlin, 2015. By choice of monomers and by controlling the macromolecular composition and architecture, multigraft copolymers can find a range of applications, including as water-dispersible nanostructures with the potential to carry drugs and other biological cargo, as nanostructured materials, as photonic materials, and as tough renewable materials. See Hadjichristidis et al., Graft Copolymers, in Encyclopedia of Polymer Science and Technology, ed. A. Seidel, John Wiley & Sons, Hoboken, N.J., 2004, Vol. 6, page 348; Cowie, Block and Graft Copolymers, in Comprehensive Polymer Science, ed., G. Allen and J. C. Bevington, Pergamon, Oxford, 1989, Vol. 3, p. 33; Gamlish et al., Polymer Chemistry, 2012, 3, 1510; Feng et al., Chemical Society Reviews, 2011, 40, 1282; and Theryo et al., Macromolecules, 2010, 43, 7394. Elastomeric multigraft copolymers have typically been prepared via anionic polymerization, which can require expensive reagents and/or polymerization initiators, extensive purification of reagents, and the exclusion of oxygen and moisture.

Accordingly, there remains a need in the art for additional synthetic methods for making multigraft copolymers, including methods that involve less stringent reaction conditions, that are compatible with the use of lower cost initiators, and/or that are compatible with a wider range of dispersing media, including water. There is also a need for methods that are more compatible with large scale polymer preparation.

### SUMMARY

This Summary lists several embodiments of the presently disclosed subject matter, and in many cases lists variations and permutations of these embodiments. This Summary is merely exemplary of the numerous and varied embodiments. Mention of one or more representative features of a given embodiment is likewise exemplary. Such an embodiment can typically exist with or without the feature(s) mentioned; likewise, those features can be applied to other embodiments of the presently disclosed subject matter, whether listed in this Summary or not. To avoid excessive repetition, this Summary does not list or suggest all possible combinations of such features.

In some embodiments, the presently disclosed subject matter provides a method of preparing a macromonomer, wherein said macromonomer comprises one or more polymeric chains attached to a polymerizable group, the method comprising: (a) polymerizing at least a first monomer via radical polymerization to form a reactive group-terminated polymeric chain, wherein said reactive group-terminated polymeric chain comprises a polymer chain having a terminal reactive group at one end, wherein said terminal reactive group comprises a hydroxyl group or an amino group; and (b) contacting said reactive group-terminated polymeric chain with a difunctional compound comprising a polymerizable group and at least one carboxylic acid group or derivative thereof, thereby forming a covalent bond between the terminal reactive group of the reactive group-terminated polymeric chain and the at least one carboxylic acid group or derivative thereof of the difunctional compound.

In some embodiments, the first monomer comprises a vinyl group. In some embodiments, the first monomer is selected from the group comprising a styrene, α-methyl styrene, ethene, propene, vinyl chloride, vinyl pyridine, methyl methacrylate, acrylonitrile, and cyclohexadiene.

In some embodiments, the polymerizing of step (a) comprises contacting the first monomer with a radical initiator and a chain transfer agent. In some embodiments, the radical initiator is 4,4′-azobis(4-cyano-1-pentanol), azobisisobutyronitrile (AIBN), or hydrogen peroxide. In some embodiments, the radical initiator is AIBN, the reactive terminal group is an amino group, and polymerizing step (a) further comprises reducing a cyano group to form the amino group. In some embodiments, the chain transfer agent comprises a mercapto group, optionally wherein the chain transfer agent is dodecyl mercaptan.

In some embodiments, the polymerizing of step (a) is performed in an emulsion comprising the first monomer and a radical initiator. In some embodiments, the polymerizing of step (a) comprises: (i) contacting the at least first monomer and a chain transfer agent with an aqueous solution comprising a surfactant to form an emulsion; and (ii) adding a solution comprising a radical initiator in an aprotic solvent to the emulsion. In some embodiments, the surfactant is sodium dodecylbenzenesulfonate (SDBS). In some embodiments, the aprotic solvent is tetrahydrofuran (THF).

In some embodiments, the polymerizable group is a carbon-carbon double bond. In some embodiments, the difunctional compound is a monocarboxylic acid or derivative thereof or is a dicarboxylic acid or derivative thereof. In some embodiments, the difunctional compound is selected from the group comprising 4-vinyl benzoic acid, maleic anhydride, fumaric acid, fumaric acid chloride, maleic acid chloride, and maleic acid. In some embodiments, the difunctional compound is a dicarboxylic acid or acid derivative and the macromonomer comprises two polymeric chains attached to a polymerizable functional group.

In some embodiments, the contacting of step (b) comprises contacting the difunctional compound and the reactive group-terminated polymeric chain with a carbodiimide, optionally dicyclohexylcarbodiimide (DCC), and a nucleophilic catalyst, optionally dimethylaminopyridine (DMAP), in an aprotic organic solvent, optionally tetrahydrofuran (THF) or dichloromethane (DCM). In some embodiments, the difunctional compound is maleic anhydride or maleic acid, and the method provides a macromonomer comprising two polymeric chains attached to a polymerizable functional group.

In some embodiments, the macromonomer has a number average molecular mass (Mₙ) of at least about 3,000 g/mol. In some embodiments, the macromonomer has a polydispersity index (PDI) of between about 1.5 and about 4.0.

In some embodiments, the presently disclosed subject matter provides a method of preparing a multigraft copolymer, said method comprising: (a) preparing a macromonomer via radical polymerization, wherein said macromonomer comprises one or more polymeric chains attached to a polymerizable group, and wherein the one or more polymeric chains comprise constitutional units from at least a first monomer; (b) contacting the macromonomer with at least a second monomer; and (c) copolymerizing the macromonomer and the second monomer to form a multigraft copolymer.

In some embodiments, the first monomer comprises a vinyl group. In some embodiments, the polymerizable group is a carbon-carbon double bond. In some embodiments, the first monomer is selected from the group comprising a styrene, α-methyl styrene, ethene, propene, vinyl chloride, vinyl pyridine, methyl methacrylate, acrylonitrile, and cyclohexadiene.

In some embodiments, preparing the macromonomer comprises contacting the at least first monomer with a radical initiator and a chain transfer agent to provide a reactive group-terminated polymeric chain comprising constitutional units from the first monomer and a terminal reactive group at one end comprising a hydroxyl group or an amino group. In some embodiments, the radical initiator is 4,4′-azobis(4-cyano-1-pentanol), azobisisobutyronitrile (AIBN), or hydrogen peroxide. In some embodiments, the chain transfer agent comprises a mercaptan, optionally wherein the chain transfer agent is dodecyl mercaptan. In some embodiments, the contacting of the first monomer, radical initiator and the chain transfer agent is performed in an emulsion, wherein said emulsion comprises water, a surfactant, and an aprotic solvent.

In some embodiments, preparing the macromonomer comprises contacting a reactive group-terminated polymeric chain comprising constitutional units from the first monomer with a difunctional compound comprising a polymerizable group and a carboxylic acid group or a derivative thereof. In some embodiments, the carboxylic acid group or derivative thereof is a carboxylic acid, an acyl chloride, or an anhydride.

In some embodiments, the difunctional compound is a monocarboxylic acid or acid derivative or a dicarboxylic acid or acid derivative. In some embodiments, the difunctional compound is selected from the group comprising 4-vinyl benzoic acid, maleic anhydride, fumaric acid, fumaric acid chloride, maleic acid chloride, and maleic acid. In some embodiments, the difunctional compound is a dicarboxylic acid or acid derivative and the macromonomer is a double-chain macromonomer.

In some embodiments, the at least second monomer is an alkene, optionally wherein the second monomer is isoprene or an alkyl acrylate. In some embodiments, the copolymerizing of step (c) comprises radical polymerization. In some embodiments, the copolymerizing of step (c) is performed in an emulsion.

In some embodiments, the macromonomer has a number average molecular mass (Mₙ) of at least about 3,000 g/mol. In some embodiments, the multigraft copolymer has a number average molecular mass (Mₙ) of at least about 50,000 g/mol.

In some embodiments, the multigraft copolymer has a centipede architecture. In some embodiments, the first monomer is styrene and the second monomer is isoprene.

In some embodiments, the presently disclosed subject matter provides a multigraft copolymer prepared by the one of the methods described herein. In some embodiments, the multigraft copolymer comprises a rubbery polymeric main chain and a plurality of glassy or semi-crystalline polymeric side chains, wherein the polymeric main chain comprises a plurality of randomly spaced branch points, and wherein each of the plurality of glassy or semi-crystalline polymeric side chains is attached to the main chain at one of the plurality of randomly spaced branch points. In some embodiments, the first monomer is styrene and the glassy or semi-crystalline polymeric side chains comprise polystyrene. In some embodiments, the second monomer is butadiene, butyl acrylate, or isoprene. In some embodiments, the second monomer is isoprene and the rubbery polymeric main chain comprises polyisoprene.

In some embodiments, the presently disclosed subject matter provides a thermoplastic elastomer and/or an adhesive comprising the multigraft copolymer prepared according to one of the methods described herein.

It is an object of the presently disclosed subject matter to provide a method of preparing macromonomers, for example, double-tailed marcromonomers, via free radical polymerization and for preparing multigraft copolymers using the macromonomers. An object of the presently disclosed subject matter having been stated hereinabove, and which is achieved in whole or in part by the presently disclosed subject matter, other objects will become evident as the description proceeds when taken in connection with the accompanying drawings and examples as best described herein below.

### BRIEF DESCRIPTION OF THE DRAWINGS

FIG. 1 is a size exclusion chromatography (SEC) trace of a hydroxyl-terminated polystyrene chain (PS-OH) prepared in an emulsion via radical polymerization.

FIG. 2 is a proton nuclear magnetic resonance (¹H-NMR) spectrum of the hydroxyl-terminated polystyrene chain (PS-OH) described for FIG. 1. The chemical structure of the PS-OH is shown at the top of the Figure. The signal from the proton on the hydroxyl group, labeled “a” in the chemical structure, is indicated by peak “a” of the spectrum at 4.75 parts-per-million (ppm). The signal from the protons on the carbon atom adjacent to the hydroxyl group, labeled “b” in the chemical structure, is indicated by peak “b” of the spectrum at 3.45-3.60 ppm.

FIG. 3 is a proton nuclear magnetic resonance (¹H-NMR) spectrum of a single-tailed macromonomer of the presently disclosed subject matter prepared via the esterification of a hydroxyl-terminated polystyrene chain and 4-vinyl benzoic acid. The chemical structure of the macromonomer is shown at the top of the Figure. The peaks corresponding to the signals from the protons labeled “a,” “b”, and “c” in the chemical structure are at 5.87, 5.39, and 3.57 parts-per-million (ppm), respectively.

FIG. 4 is a synthetic scheme showing the synthesis of a double-tailed macromonomer (PS-ma-PS) of the presently disclosed subject matter where maleic anhydride (MAH) is esterified with two equivalents of hydroxyl-terminated polystryrene (PS-OH). A photograph of a powder of the macromonomer is shown in the lower right-hand side of the Figure.

FIG. 5A is a proton nuclear magnetic resonance (¹H-NMR) spectrum of a single-tailed macromonomer formed by the esterification of one equivalent of hydroxyl-terminated polystryrene with maleic anhydride as described in FIG. 4. A chemical structure of the single-tailed macromonomer is shown above the spectrum. The spectrum includes an enlargement of the portion of the spectrum including the peaks corresponding to the signal from the alkene protons (marked “a,” and “a’” on the spectrum and in the chemical structure).

FIG. 5B is a proton nuclear magnetic resonance (¹H-NMR) spectrum of the double-tailed macromonomer described for FIG. 4. The chemical structure of the double-tailed macromonomer is also shown above the spectrum.

FIG. 6 is a partial size exclusion chromatography (SEC) trace of a mixture of the single- and double-tailed macromonomers prepared by esterification of maleic anhydride with hydroxyl-terminated polystyrene. The peak corresponding to the single-tailed macromonomer (PS-MAH) is labeled (A), while that for the double-tailed macromonomer (PS-MAH-PS) is labeled (B).

FIG. 7 is a synthetic scheme showing the synthesis of a double-tailed macromonomer (PS-FA-PS) of the presently disclosed subject matter where fumaric acid (FA) is esterified with hydroxyl-terminated polystyrene. A photograph of a powder of the macromonomer is shown at the right-hand side of the Figure.

FIG. 8 is a partial size exclusion chromatography (SEC) trace of a reaction mixture from the synthesis of double-tailed macromonomer prepared by esterifying fumaric acid with hydroxyl-terminated polystyrene. The peak corresponding to unreacted hydroxyl-terminated polystyrene (PS-OH) is labeled (C), while that for the double-tailed macromonomer (PS-FA-PS) is labeled (D).

FIG. 9 is proton nuclear magnetic resonance (¹H-NMR) spectrum of double-tailed macromonomer prepared by esterifying fumaric acid with hydroxyl-terminated polystyrene. The chemical structure of the macromonomer (labeled “(D)”) is shown at the top of the Figure. The section of the spectrum where the signal corresponding to the alkene protons (“a” in the chemical structure) would be found is enlarged.

FIG. 10 is a synthetic scheme showing the synthesis of a double-tailed macromonomer (PS-MA-PS) by esterification of maleic acid (MA) with hydroxyl-terminated polystyrene. A photograph of a powder of the macromonomer is shown on the right-hand side of the Figure.

FIG. 11 is a partial size exclusion chromatography (SEC) trace of a reaction mixture from the synthesis of double-tailed macromonomer prepared by esterifying maleic acid with hydroxyl-terminated polystyrene. The peak corresponding to unreacted hydroxyl-terminated polystyrene (PS-OH) is labeled (C), while that for the double-tailed macromonomer (PS-MA-PS) is labeled (E).

FIG. 12 is a schematic drawing showing the synthesis of maleoyl dichloride from oxalyl chloride and maleic acid.

FIG. 13 is a proton nuclear magnetic resonance (¹H-NMR) spectrum of maleoyl dichloride. The peak corresponding to the vinyl protons is labeled “H”.

FIG. 14 is a schematic drawing showing the synthesis of a double-tailed macromonomer in tetrahydrofuran (THF) at room temperature using maleoyl dichloride (MC) and hydroxyl-terminated polystyrene (PS-OH). Triethylamine (TEA) is used as a catalyst.

FIG. 15 is a gel permeation chromatography (GPC) trace of the double-tailed polystyrene (PS) macromonomer product described for FIG. 14.

FIG. 16 is a proton nuclear magnetic resonance (¹H-NMR) spectrum of the double-tailed polystyrene (PS) macromonomer described for FIG. 14. The peak corresponding to the vinyl protons is labeled “H”.

FIG. 17 is a schematic drawing showing the synthesis of multigraft copolymer using double-tailed polystyrene (PS) macromonomers. The macromonomer can be copolymerized with monomers such as n-butyl acrylate or methyl methacrylate via radical polymerization to provide a multigraft copolymer with centipede architecture, where the PS grafts are attached to a poly(butyl acrylate) (PBA) or poly(methyl methacrylate) (PMMA) backbone.

FIG. 18 is a proton nuclear magnetic resonance (¹H-NMR) spectrum of a multigraft copolymer with a poly(methyl methacrylate) (PMMA) backbone and polystyrene (PS) grafts prepared as described in FIG. 17. Peaks corresponding to the aromatic protons from the PS and the methyl group protons from the PMMA are labelled.

FIG. 19 is a proton nuclear magnetic resonance (¹H-NMR) spectrum of a multigraft copolymer with a poly(butyl acrylate) (PBA) backbone and polystyrene (PS) grafts prepared as described in FIG. 17. Peaks corresponding to the aromatic protons from the PS and the protons on the carbon adjacent to the oxygen of the ester linkage in the PBA are labelled.

FIG. 20A is a gel permeation chromatography (GPC) trace of a multigraft copolymer comprising a poly(methyl methacrylate) (PMMA) backbone and polystyrene (PS) grafts as described for FIGS. 17 and 18.

FIG. 20B is a gel permeation chromatography (GPC) trace of a multigraft copolymer comprising a poly(butyl acrylate) (PBA) backbone and polystyrene (PS) grafts as described for FIGS. 17 and 19.

### DETAILED DESCRIPTION

The presently disclosed subject matter will now be described more fully hereinafter with reference to the accompanying Examples and Drawings, in which representative embodiments are shown. The presently disclosed subject matter can, however, be embodied in different forms and should not be construed as limited to the embodiments set forth herein. Rather, these embodiments are provided so that this disclosure will be thorough and complete, and will fully convey the scope of the embodiments to those skilled in the art.

Unless otherwise defined, all technical and scientific terms used herein have the same meaning as commonly understood by one of ordinary skill in the art to which this presently described subject matter belongs. All publications, patent applications, patents, and other references mentioned herein are incorporated by reference in their entirety.

Throughout the specification and claims, a given chemical formula or name shall encompass all optical and stereoisomers, as well as racemic mixtures where such isomers and mixtures exist.

### I. Definitions

While the following terms are believed to be well understood by one of ordinary skill in the art, the following definitions are set forth to facilitate explanation of the presently disclosed subject matter.

Following long-standing patent law convention, the terms “a”, “an”, and “the” refer to “one or more” when used in this application, including the claims. Thus, for example, reference to “a solvent” includes a plurality or mixture of solvents, and so forth.

Unless otherwise indicated, all numbers expressing quantities of size, weight, percentage, temperature or other reaction conditions, and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

As used herein, the term “about”, when referring to a value or to an amount of size, weight, concentration, temperature, percentage, or the like is meant to encompass variations of, in some embodiments ±20%, in some embodiments ±10%, in some embodiments ±5%, in some embodiments ±1%, and in some embodiments ±0.1% from the specified amount, as such variations are appropriate to perform the disclosed methods.

The use of the term “or” in the claims is used to mean “and/or” unless explicitly indicated to refer to alternatives only or the alternatives are mutually exclusive, although the disclosure supports a definition that refers to only alternatives and “and/or.” As used herein “another” can mean at least a second or more.

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

The term “comprising”, which is synonymous with “including,” “containing,” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising”, “consisting of”, and “consisting essentially of”, where one of these three terms is used herein, the presently disclosed and claimed subject matter can include the use of either of the other two terms.

As used herein, the term “anionic polymerization” refers to an ionic polymerization in which the kinetic chain carriers are anions. Accordingly, an anionic polymerization reaction is a chain reaction in which the growth of the polymer chain proceeds by reaction(s) between a monomer(s) and a reactive site(s) on the polymer chain with regeneration of the reactive site(s) at the end of each growth step. Anionic polymerization typically is used to produce macromolecules from monomers that contain a carbon-carbon double bond, such as styrene and/or butadiene. Such reactions are referred to as anionic vinyl polymerization. For example, anionic polymerization can take place with vinyl monomers that can also comprise electron-withdrawing groups, such as nitrile, carboxyl, phenyl, and vinyl, or with monomers that can stabilize the anions through resonance. These polymerizations are initiated by nucleophilic addition to the double bond of the monomer, wherein the initiator comprises an anion, such as hydroxide, alkoxides, cyanide, or a carbanion. In some embodiments, the carbanion is generated from an organometallic species, such as an alkyl lithium, e.g., butyl lithium, or a Grignard reagent.

The terms “radical polymerization” and “free radical polymerization” refer to a polymerization in which the kinetic chain carriers are radicals. A radical polymerization is initiated by the creation of a radical from an initiator compound, compounds, or system, followed by transfer of the radical to a monomer. Various initiators can be used. Many initiators include a peroxy or azo bond. Radicals can be formed from initiators, for example, via thermal decomposition of the initiator, photolysis, redox reactions, electrochemically, and via ionizing radiation, among other ways. Monomers that can be polymerized via radical polymerization include, but are not limited to, monomers that comprise carbon-carbon double bonds (e.g., alkenes) and monomers that comprise carbon-oxygen double bonds (e.g., ketones and aldehydes).

As used herein, a “monomer” refers to a molecule that can undergo polymerization, thereby contributing constitutional units, i.e., an atom or group of atoms, to the essential structure of a macromolecule.

As used herein, a “macromolecule” refers to a molecule of high relative molecular mass, the structure of which comprises the multiple repetition of units derived from molecules of low relative molecular mass, e.g., monomers and/or oligomers.

An “oligomer” refers to a molecule of intermediate relative molecular mass, the structure of which comprises a small plurality (e.g., 2, 3, 4, 5, 6, 7, 8, 9, or 10) of repetitive units derived from molecules of lower relative molecular mass.

A “polymer” refers to a substance comprising macromolecules. In some embodiments, the term “polymer” can include both oligomeric molecules and molecules with larger numbers (e.g., >10, >20,>50, >100) of repetitive units. In some embodiments, “polymer” refers to macromolecules with at least 10 repetitive units.

A “copolymer” refers to a polymer derived from more than one species of monomer.

As used herein, “macromonomer” refers to a polymer having at least one functional group (e.g. a vinyl or other carbon-carbon double bond) through which polymerization reactions can proceed. Macromonomers are thus macromolecular monomers which can be converted to homo- or copolymers of defined structures. In some embodiments, a macromonomer can comprise more than one (e.g., 2, 3, 4, 5, 6, etc.) polymeric chain (e.g., linear polymeric chain) attached to one functional (e.g., polymerizable) group. Macromonomers with two polymeric chains attached to one polymerizable functional group can be referred to as “double-tailed” or “double chain” macromonomers. In some embodiments, the macromonomer comprises a single polymeric chain attached to one polymerizable functional group. Such macromonomers can be referred to as “single-tailed” or “single chain” macromonomers.

As used herein, a “block macromolecule” refers to a macromolecule that comprises blocks in a linear sequence. A “block” refers to a portion of a macromolecule that has at least one feature that is not present in the adjacent portions of the macromolecule. A “block copolymer” refers to a copolymer in which adjacent blocks are constitutionally different, i.e., each of these blocks comprises constitutional units derived from different characteristic species of monomer or with different composition or sequence distribution of constitutional units.

For example, a diblock copolymer of polybutadiene and polystyrene is referred to as polybutadiene-block-polystyrene. Such a copolymer is referred to generically as an “AB block copolymer.” Likewise, a triblock copolymer can be represented as “ABA.” Other types of block polymers exist, such as multiblock copolymers of the (AB)ₙ type, ABC block polymers comprising three different blocks, and star block polymers, which have a central point with three or more arms, each of which is in the form of a block copolymer, usually of the AB type.

As used herein, a “graft macromolecule” or “graft polymer” refers to a macromolecule comprising one or more species of block connected to the main chain as a side chain or chains, wherein the side chain(s) comprises constitutional or configurational features that differ from those in the main chain. The term “multigraft copolymer” refers to a graft copolymer with at least two or more side chains (e.g., at least three, at least 5, or at least 10 side chains).

The term “regular multigraft macromolecule” can refer to a multigraft copolymer where the branch points at which the side chains are attached to the main chain are at evenly spaced intervals, i.e., where the main chain segment between each branch point is about the same length.

A “branch point” (or “junction point”) refers to a point on a chain (e.g., a main chain) at which a branch is attached. A “branch,” also referred to as a “side chain,” “graft,” or “pendant chain,” is an oligomeric or polymeric offshoot from a macromolecule chain. An oligomeric branch can be termed a “short chain branch,” whereas a polymeric branch can be termed a “long chain branch.”

A “chain” refers to the whole or part of a macromolecule, an oligomer, or a block comprising a linear or branched sequence of constitutional units between two boundary constitutional units, wherein the two boundary constitutional units can comprise an end group, a branch point, or combinations thereof.

A “main chain” or “backbone” refers to a linear chain from which all other chains are regarded as being pendant.

A “side chain” refers to a linear chain which is attached to a main chain at a branch point.

An “end group” (or “terminal group”) refers to a constitutional unit that comprises the extremity of a macromolecule or oligomer and is attached to only one constitutional unit of a macromolecule or oligomer.

A “comb macromolecule” refers to a multigraft copolymer comprising a main chain with multiple branch points from each of which one linear side chain emanates.

A “centipede macromolecule” refers to a multigraft copolymer comprising a main chain with multiple branch points, wherein from each branch point two linear side chains emanate.

A “star polymer” refers to a polymer comprising a macromolecule comprising a single branch point from which a plurality of linear chains (or arms) emanate. A star polymer or macromolecule with “n” linear chains emanating from the branch point is referred to as an “n-star polymer.” If the linear chains of a star polymer are identical with respect to constitution and degree of polymerization, the macromolecule is referred to as a “regular star macromolecule.” If different arms of a star polymer comprise different monomeric units, the macromolecule is referred to as a “variegated star polymer.”

A “miktoarm star polymer” refers to a star polymer comprising chemically different (i.e., “mixed”) arms, thereby producing a star polymer having the characteristic of chemical asymmetry.

The term “latex” as used herein can refer to a colloidal suspension of polymer particles in a liquid. In some embodiments, the latex can be obtained as the product of an emulsion, mini-emulsion, micro-emulsion or dispersion polymerization.

The term “rubbery” can refer to a polymer having a glass transition temperature (T_{g}) of about 0° C. or less.

The term “glassy” can refer to a polymer having a T_{g} of about 60° C. or more.

Polydispersity (PDI) refers to the ratio (M_{w}/Mₙ) of a polymer sample. M_{w} refers to the mass average molar mass (also commonly referred to as weight average molecular weight). Mₙ refers number average molar mass (also commonly referred to as number average molecular weight).

As used herein the term “alkyl” can refer to C₁₋₂₀ inclusive, linear (i.e., “straight-chain”), branched, or cyclic, saturated or at least partially and in some cases fully unsaturated (i.e., alkenyl and alkynyl) hydrocarbon chains, including for example, methyl, ethyl, propyl, isopropyl, butyl, isobutyl, tert-butyl, pentyl, hexyl, octyl, ethenyl, propenyl, butenyl, pentenyl, hexenyl, octenyl, butadienyl, propynyl, butynyl, pentynyl, hexynyl, heptynyl, and allenyl groups. “Branched” refers to an alkyl group in which a lower alkyl group, such as methyl, ethyl or propyl, is attached to a linear alkyl chain. “Lower alkyl” refers to an alkyl group having 1 to about 8 carbon atoms (i.e., a C₁₋₈ alkyl), e.g., 1, 2, 3, 4, 5, 6, 7, or 8 carbon atoms. “Higher alkyl” refers to an alkyl group having about 10 to about 20 carbon atoms, e.g., 10, 11, 12, 13, 14, 15, 16, 17, 18, 19, or 20 carbon atoms. In certain embodiments, “alkyl” refers, in particular, to C₁₋₈ straight-chain alkyls. In other embodiments, “alkyl” refers, in particular, to C₁₋₈ branched-chain alkyls.

Alkyl groups can optionally be substituted (a “substituted alkyl”) with one or more alkyl group substituents, which can be the same or different. The term “alkyl group substituent” includes but is not limited to alkyl, substituted alkyl, halo, arylamino, acyl, hydroxyl, aryloxyl, alkoxyl, alkylthio, arylthio, aralkyloxyl, aralkylthio, carboxyl, alkoxycarbonyl, oxo, and cycloalkyl. In some embodiments, there can be optionally inserted along the alkyl chain one or more oxygen, sulfur or substituted or unsubstituted nitrogen atoms, wherein the nitrogen substituent is hydrogen, lower alkyl (also referred to herein as “alkylaminoalkyl”), or aryl.

Thus, as used herein, the term “substituted alkyl” includes alkyl groups, as defined herein, in which one or more atoms or functional groups of the alkyl group are replaced with another atom or functional group, including for example, alkyl, substituted alkyl, halogen, aryl, substituted aryl, alkoxyl, hydroxyl, nitro, amino, alkylamino, dialkylamino, sulfate, and mercapto.

The term “aryl” is used herein to refer to an aromatic substituent that can be a single aromatic ring, or multiple aromatic rings that are fused together, linked covalently, or linked to a common group, such as, but not limited to, a methylene or ethylene moiety. The common linking group also can be a carbonyl, as in benzophenone, or oxygen, as in diphenylether, or nitrogen, as in diphenylamine. The term “aryl” specifically encompasses heterocyclic aromatic compounds. The aromatic ring(s) can comprise phenyl, naphthyl, biphenyl, diphenylether, diphenylamine and benzophenone, among others. In particular embodiments, the term “aryl” means a cyclic aromatic comprising about 5 to about 10 carbon atoms, e.g., 5, 6, 7, 8, 9, or 10 carbon atoms, and including 5- and 6-membered hydrocarbon and heterocyclic aromatic rings.

The aryl group can be optionally substituted (a “substituted aryl”) with one or more aryl group substituents, which can be the same or different, wherein “aryl group substituent” includes alkyl, substituted alkyl, aryl, substituted aryl, aralkyl, hydroxyl, alkoxyl, aryloxyl, aralkyloxyl, carboxyl, acyl, halo, nitro, alkoxycarbonyl, aryloxycarbonyl, aralkoxycarbonyl, acyloxyl, acylamino, aroylamino, carbamoyl, alkylcarbamoyl, dialkylcarbamoyl, arylthio, alkylthio, alkylene, and —NR′R″, wherein R′ and R″ can each be independently hydrogen, alkyl, substituted alkyl, aryl, substituted aryl, and aralkyl.

Thus, as used herein, the term “substituted aryl” includes aryl groups, as defined herein, in which one or more atoms or functional groups of the aryl group are replaced with another atom or functional group, including for example, alkyl, substituted alkyl, halogen, aryl, substituted aryl, alkoxyl, hydroxyl, nitro, amino, alkylamino, dialkylamino, sulfate, and mercapto.

Specific examples of aryl groups include, but are not limited to, cyclopentadienyl, phenyl, furan, thiophene, pyrrole, pyran, pyridine, imidazole, benzimidazole, isothiazole, isoxazole, pyrazole, pyrazine, triazine, pyrimidine, quinoline, isoquinoline, indole, carbazole, and the like.

“Heteroaryl” as used herein refers to an aryl group that contains one or more non-carbon atoms (e.g., O, N, S, Se, etc) in the backbone of a ring structure. Nitrogen-containing heteroaryl moieties include, but are not limited to, pyridine, imidazole, benzimidazole, pyrazole, pyrazine, triazine, pyrimidine, and the like.

“Aralkyl” refers to an -alkyl-aryl group, optionally wherein the alkyl and/or aryl moiety is substituted (e.g., with an alkyl or aryl group substituent).

The terms “halo”, “halide”, or “halogen” as used herein refer to fluoro, chloro, bromo, and iodo groups.

The term “hydroxyl” refers to the —OH group.

The terms “mercapto,” “mercaptan,” and “thiol” refer to compounds comprising the group —SH or —SR, wherein R is alkyl, substituted alkyl, aralkyl, substituted aralkyl, aryl, and substituted aryl.

The term “vinyl” can refers to the group —CH═CH₂. However, as used herein, unless specified otherwise, the term “vinyl” can also refer to any alkenyl group (i.e., any group containing a carbon-carbon double bond).

The term “cyano” refers to the group —CN.

The terms “carboxylate” and “carboxylic acid” can refer to the groups —C(═O)O^{—} and —C(═O)OH, respectively or to molecules containing such groups, such as benzoic acid or alkanoic acids (e.g., hexanoic acid, butanoic acid), etc. Derivatives of carboxylic acid groups include, but are not limited to, acid halides (also known as acyl halides, e.g., acid or acyl chlorides), anhydrides, esters, or amides, i.e., compounds wherein the —OH of the carboxylic acid group is replaced by —X, —OC(═O)R, OR, or NRR′, respectively, wherein X is a halide, and R and R′ are each H, alkyl, substituted alkyl, aralkyl, substituted aralkyl, aryl or substituted aryl.

The term “ester” refers to a group or compound containing a group having the structure: R′—C(═O)—O—R, wherein each of R and R′ are selected from alkyl, substituted alkyl, aralkyl, substituted aralkyl, aryl, and substituted aryl.

The term “amide” refers to a group or compound containing a group having the structure: R′—C(═O)—NRR″, wherein each of R and R′ are selected from alkyl, substituted alkyl, aralkyl, substituted aralkyl, aryl, and substituted aryl and wherein R″ is H, alkyl, substituted alkyl, aralkyl, substituted aralkyl, aryl, or substituted aryl. In some embodiments, R″ is H.

The term “alkyl acrylate” refers to a compound having the formula CH₂═CHC(═O)OR, wherein R is an alkyl or substituted alkyl group. In some embodiments, “alkyl acrylate” refers to a compound of the formula CH₂═CHC(═O)OR, wherein R is a C₁-C₆ alkyl group.

The term “aprotic solvent” refers to a solvent molecule which can neither accept nor donate a proton. Typical aprotic solvents include, but are not limited to, acetone, acetonitrile, benzene, butanone, butyronitrile, carbon tetrachloride, chlorobenzene, chloroform, 1,2-dichloroethane, dichloromethane (DCM), diethyl ether, dimethylacetamide, N,N-dimethylformamide (DMF), dimethylsulfoxide (DMSO), 1,4-dioxane, ethyl acetate, ethylene glycol dimethyl ether, hexane, N-methylpyrrolidone, pyridine, tetrahydrofuran (THF), and toluene. Certain aprotic solvents are polar solvents. Examples of polar aprotic solvents include, but are not limited to, acetone, acetonitrile, butanone, N,N-dimethylformamide, and dimethylsulfoxide. Certain aprotic solvents are non-polar solvents (e.g., non-polar organic solvents). Examples of nonpolar organic solvents include, but are not limited to, diethyl ether, aliphatic hydrocarbons, such as hexane, aromatic hydrocarbons, such as benzene and toluene, and halogenated hydrocarbons, such as carbon tetrachloride, DCM, and chloroform.

### II. Radical Polymerization Preparation of Macromonomers and Graft Copolymers

Thermoplastic elastomers (TPEs) are materials with rubber-like properties. They have various applications in daily life, for example, as elastomers and adhesives. Most commercial TPEs, such as SBS and SIS (S=polystyrene, B=polybutadiene, I=polyisoprene) are linear triblock copolymers synthesized by anionic polymerization. In contrast to conventional rubbers, which achieve their elastic properties by chemical cross-links between macromolecules, TPEs exhibit rubber-like behavior due to the formation of hard physically cross-linked domains in a soft continuous phase. See Holdon et al., Thermplastic Elastomers, Hanser, Munich, 1996; and Spontak and Patel, Current opinion in colloid & interface science, 2000, 5, 333.

Many efforts have been made to develop TPEs with improved elasticity and mechanical properties. See Wisse et al., Macromolecules, 2008, 42, 524; and Cohn and Salomon, Biomaterials, 2005, 26, 2297. A class of TPEs was recently developed based on multigraft copolymers having regularly spaced tri-, tetra- and hexafunctional junction points, in which a rubbery backbone (e.g., polyisoprene) behaves as a continuous matrix with multiple glassy domains from branched segments (e.g., polystyrene) at each junction point. See Beyer et al., Macromolecules, 2000, 33, 2039; Weidisch et al., Macromolecules, 2001, 34, 6333; Mays et al., Macromolecular Symposia, 2004, 215, 111; and Uhrig and Mays, Polymer Chemistry, 2011, 2, 69. The microphase separated morphologies formed by these “comb”, “centipede” and “barbwire” architectures were similar to those of conventional linear triblock copolymers, but they exhibit poorer long range order. The regular multigraft copolymers were synthesized by high vacuum anionic polymerization.

Multigraft copolymers having randomly spaced tri-, tetra-, and hexafunctional junction points comprising a rubbery backbone and glassy or semi-crystalline side chains can also have elastic properties. See U.S. Patent Application Publication No. 2014/0161858, incorporated herein by reference in its entirety. The random multigraft copolymers can have tunable modulus with superior mechanical properties compared to that of traditional PS-PI-PS triblock copolymer type thermoplastic elastomers.

Generally, regular and random multigraft copolymers can be prepared by copolymerizing a monomer (e.g. isoprene) related to the constitutional units of the copolymer backbone or main chain with macromonomers (e.g. polystyrene (PS) macromonomers) comprising polymeric chains that can make up the side chains of the resulting copolymer. Thus, building blocks for synthesizing multigraft copolymers can include single- or double-tailed macromonomers with one or two polymeric side chains connected at the same polymerizable functionality. The term “random multigraft copolymer” as used herein can refer to multigraft copolymers with non-regularly spaced branch points and/or to multigraft copolymers wherein the sequential distribution of the backbone monomeric units and the macromonomeric units that include the branch segments obeys known statistical laws, including, but not limited to Markovian statistics and/or can relate to the relative reactivities and concentrations of the backbone monomer and the macromonomer.

Macromonomers have typically been prepared via living polymerization techniques (e.g., anionic polymerization) and, thus, can be relatively expensive to make, and require the extensive purification of reactants, with polymerization performed with rigorous exclusion of oxygen, moisture, and other potentially terminating impurities. Therefore, synthesis of the macromonomers, as well as of the copolymers prepared from the macromonomers, has not been readily amenable to large scale production, such as that which would be performed in order to prepare copolymers for many commercial applications.

The presently disclosed subject matter is based in part on the preparation of macromonomers (e.g., single- and double-tailed macromonomers) by free radical polymerization in solution or emulsion. A free radical polymerization-based synthesis of the macromonomers can offer several advantages. For instance, free radical polymerization is applicable to a wider range of monomers than anionic polymerization. Radical polymerization can be performed under less stringent reaction conditions, using lower cost initiators, and using a wider choice of dispersing media, including water. In addition, emulsion free-radical polymerization can be well-suited to the synthesis of polymers and copolymers of high molecular weight.

The synthesis of the macromonomers can include the synthesis of a suitable end-functionalized polymeric (e.g., linear polystyrene, poly(methyl methacrylate, or another glassy or semi-crystalline polymer) chain using a suitable end-functionalized free radical initiator. One example of such an initiator is 4,4′-azobis(4-cyano-1-pentanol) (AIBN-OH). This initiator attaches a hydroxyl (i.e., —OH) group at the alpha end of the polymer chain. A simple chain transfer agent (e.g., comprising a mercapto or halide group) can also be used to terminate the omega end of the polymeric chain, such that only one end of the polymeric chain includes a hydroxyl group.

The hydroxyl group can then be reacted with a suitable group on a difunctional compound to form a covalent linkage to the difunctional compound. For instance, the hydroxyl group of a hydroxyl-terminated polymeric chain can form an ester with the difunctional compound if the compound contains a carboxylic acid or a suitable derivative thereof, such as an acyl chloride or anhydride. The difunctional compound can also contain a polymerizable group, e.g., a carbon-carbon double bond, separate from the carboxylic acid or acid derivative group. In some embodiment, the difunctional compound can comprise a suitable group or groups that are capable of forming covalent linkages with more than one hydroxyl group. For example, the difunctional compound can comprise a cyclic anhydride or two or more carboxylic acid or acyl chloride groups, and can form ester linkages with the hydroxyl groups of two or more separate hydroxyl-terminated polymeric chains, thereby forming a multi-tailed macromonomer, e.g., a double-tailed macromonomer.

In some embodiments, polymerization can be initiated with a less expensive initiator than AIBN-OH, such as azobisiosbutyronitrile (AIBN). Use of AIBN can result initially in a polymeric chain with a terminal cyano group. The cyano group can be reduced (e.g., using lithium aluminum hydride (LAH) or via catalytic hydrogenation) to form a primary amine group (i.e., a —NH₂ group) that can react with a carboxylic acid, acyl halide, or anhydride to form an amide linkage.

Hydrogen peroxide can also be used as a radical initiator. Typically, a high reaction temperature is used when hydrogen peroxide is the initiator, due to the relatively high bond dissociation energy of the HO—OH peroxy bond. However, porous tin phosphonates have recently been reported to promote HOOH-initiated polymerization of styrene, giving 85% yield in bulk polymerization at room temperature. See Bhaumik et al., Catalysis Science & Technology, 2, 613 (2012).

Accordingly, in some embodiments, the presently disclosed subject matter provides a method of preparing a macromonomer, wherein the macromonomer comprises one or more polymeric chains attached to a polymerizable group, the method comprising: (a) polymerizing at least a first monomer via radical polymerization to form a reactive group-terminated polymeric chain, wherein said reactive group-terminated polymeric chain comprises a polymer chain (e.g., a linear polymer chain) having a terminal reactive group at one end, wherein said terminal reactive group comprises a hydroxyl group or an amino group; and (b) contacting said reactive group-terminated polymeric chain with a difunctional compound comprising a polymerizable group and at least one carboxylic acid group or derivative thereof, thereby forming a covalent bond between the terminal reactive group of the reactive group-terminated polymeric chain and the at least one carboxylic acid group or derivative thereof.

The first monomer can be any monomer that polymerizes via free radical polymerization. In some embodiments, the first monomer comprises a vinyl group. Thus, in some embodiments, the first monomer can be selected from the group including, but not limited to, styrenes (e.g., styrene); α-methyl styrene; alkenes (e.g., ethene (also referred to as ethylene, i.e., CH₂═CH₂), propene, butene, etc); vinyl chloride; vinyl acetate; vinyl fluoride; vinyl pyridine; dienes such as cylcohexadiene; and the like. In some embodiments, the first monomer is a monomer that can form a glassy or semi-crystalline polymer. In some embodiments, the first monomer is selected from the group comprising a styrene, α-methyl styrene, ethene, propene, vinyl chloride, vinyl pyridine, methyl methacrylate, acrylonitrile, and cyclohexadiene.

In some embodiments, the polymerizing can comprise contacting the at least first monomer with a radical initiator and a chain transfer agent. For example, the at least first monomer and the chain transfer agent can be mixed or dissolved in a solvent to form a homogeneous solution. Then, the radical initiator can be added and polymerization initiated to form polymeric chains with a suitable terminal reactive group (e.g., an amino or hydroxyl group) or a reactive group precursor (e.g., a nitrile) at one end. The second end of the polymeric chain can be a non-reactive group, such as an unfunctionalized alkyl or aryl group. In some embodiments, only one monomer is used in the polymerizing step, resulting in reactive group-terminated homopolymeric chains. In some embodiments, the chain transfer agent is a mercapto-containing compound, such as dodecyl mercaptan (n-DM). In some embodiments, when the radical initiator is a thermally activatable radical initiator, the mixture is heated to initiate radical formation.

Suitable thermally activatable radical initiators can include, for example, those of the peroxy and azo type. These include, but are not limited to, hydrogen peroxide, peracetic acid, t-butyl hydroperoxide, di-t-butyl peroxide, dibenzoyl peroxide, benzoyl hydroperoxide, 2,4-dichlorobenzoyl peroxide, 2,5-dimethyl-2,5-bis(hydroperoxy)hexane, perbenzoic acid, t-butyl peroxypivalate, t-butyl peracetate, dilauroyl peroxide, dicapryloyl peroxide, distearoyl peroxide, dibenzoyl peroxide, diisopropyl peroxydicarbonate, dodecyl peroxydicarbonate, dieicosyl peroxydicarbonate, di-t-butyl perbenzoate, azobisisobutyronitrile (AIBN), 4,4′-azobis(4-cyano-1-pentanol) (AIBN-OH), 2,2′-azobis-2,4-dimethylvaleronitrile, ammonium persulfate, potassium persulfate, sodium persulfate and sodium perphosphate.

Redox initiators can involve the use of a plurality of initiator components. For instance, redox initiation typically involves the use of an oxidizing agent (or agents) and a reducing agent, at least one of which is soluble in water. Suitable oxidizing agents include, for example, persulfate salts and hydroperoxides. Suitable reducing agents include, but are not limited to, glucose and sulfites. In some embodiments, redox initiation includes the use of a redox catalyst, such as an iron compound. A suitable redox initiator can include a combination of cumene hydroperoxide, iron sulfate, ethylenediaminetetraacetic acid (EDTA), and sodium formaldehyde sulfoxylate (SFS).

In some embodiments, the initiator is AIBN, AIBN-OH, or hydrogen peroxide. In some embodiments, the hydrogen peroxide is used in combination with a porous tin phosphonate.

In some embodiments, the radical polymerization is performed in an emulsion. Accordingly, in some embodiments, the first monomer and the chain transfer agent are emulsified in water containing one or more suitable surfactants to provide a homogeneous emulsion. In order to provide the homogeneous emulsion, a mixture of the first monomer, chain transfer agent, water and surfactant can be agitated, e.g., via sonication, high-pressure homogenizer, manual or robotic shaking, etc. In some embodiments, the emulsion can further comprise one or more organic solvents, such as a non-polar solvent, like an aromatic solvent (e.g., toluene) or an alkane. Then, the radical initiator (e.g., dissolved in a suitable solvent) can be added. In some embodiments, the solvent is an aprotic solvent, such as tetrahydrofuran (THF). Anionic, neutral or cationic surfactants can be used. In some embodiments, the emulsion can also include one or more co-surfactants, non-surfactant stabilizers (e.g., a water soluble polymer, such as polyvinyl alcohol), buffering agents, inert salts, and/or preservatives. In some embodiments, the emulsion includes an anionic and/or nonionic surfactant. Anionic surfactants include, but are not limited to, sodium lauryl sulfate, sodium tridecyl ether sulfate, dioctylsulfosuccinate sodium salt and sodium salts of alkylaryl polyether sulfonates (e.g., sodium dodecylbenzene sulfonate (SDBS)). Nonionic surfactants include, but are not limited to, alkylaryl polyether alcohols and ethylene oxide-propylene oxide copolymers. In some embodiments, the surfactant is SDBS.

In some embodiments, the initiator is thermally activated and a homogeneous emulsion of first monomer and chain transfer agent is heated prior to the addition of the initiator. In some embodiments, the emulsion is heated after addition of the initiator. In either case, the heating can be, for example, to between about 40° C. and about 100° C. (e.g., about 40, 45, 50, 55, 60, 65, 70, 75, 80, 85, 90, 95 or about 100° C.). In some embodiments, the heating is to between about 50° C. and about 90° C. In some embodiments, the heating is to about 60° C. or to about 80° C.

The polymerizing can continue for any desired length of time (e.g., to provide a desired polymer chain weight or monomer conversion level). In some embodiments, samples of polymer chain can be taken during the polymerization to allow for characterization of the remaining monomers and the polymer chains by absolute molecular weight methods such as osmometry, matrix assisted laser desorption ionization time-of-flight mass spectrometry (MALDI-TOF-MS), and light scattering, as well as by gel permeation chromatography (GPC), size exclusion chromatography (SEC), nuclear magnetic resonance (NMR) spectrometry, and infrared (IR) spectrometry. In some embodiments, the polymerization can continue for between about 1 hour and about 24 hours (e.g., 1, 2, 3, 4, 5, 6, 7, 8, 9, 10, 11, 12, 13, 14,15, 16, 17, 18, 19, 20, 21, 22, 23, or 24 hours). In some embodiments, the polymerization can continue for between about 1 hours and about 8 hours. In some embodiments, the polymerization can continue for between about 3 hours and about 5 hours. Polymerization can be stopped by demulsification, such as by adding a salt (e.g., sodium chloride) to break the emulsion.

In some embodiments, the polymer chains can be precipitated into an alcohol (e.g. methanol) and dried. The drying can be done under vacuum, with or without heating (e.g., to about 30° C., 35° C. or 40° C.). In some embodiments, the polymer chains can be purified, e.g. to remove any remaining monomer or to provide polymer chains with a particular weight range. Purification can be performed by any suitable technique, such as, but not limited to, via fractionation. Thus, in some embodiments, the presently disclosed methods can further include drying and/or purifying the polymer chains.

In some embodiments, one or more additional steps are required to provide a polymeric chain with a suitable terminal reactive group, i.e., an amino or hydroxyl group. For instance, when the radical initiator is AIBN, polymerization provides a polymeric chain where the terminal group is a cyano group. To transform the cyano group into an amino group, the polymeric chain is contacted with a suitable reagent or reagents under conditions suitable to reduce the cyano group into a primary amine group (e.g., catalytic hydrogenation or reduction by a suitable hydride reagent, such as LAH). In some embodiments, the suitable reagent or reagents comprise hydrogen (H₂) and a metal catalyst (e.g., a Pt catalyst), and the cyano-terminated polymeric chain is hydrogenated to provide an amino-terminated polymeric chain. Thus, in some embodiments, polymerizing step (a) further comprises reducing a cyano group to form the amino group.

In some embodiments, the reactive group-terminated polymeric chain can have a number average molecular mass (Mₙ) of between about 3,000 g/mol and about 30,000 g/mol (e.g., about 3,000; 5,000; 10,000; 12,000; 15,000; 18,000; 20,000; 23,000; 25,000; 27,000; or about 30,000 g/mol). In some embodiments, the reactive group-terminated polymeric chain is hydroxyl-terminated polystyrene with a Mₙ of about 23 kilograms per mole. In some embodiments, the reactive group-terminated polymeric chain can have a polydispersity index (PDI) of between about 1.5 and about 4.0 (e.g., about 1.5, 1.6, 1.7, 1.8, 1.9, 2.0, 2.2, 2.4, 2.6, 2.8, 3.0, 3.2, 3.4, 3.6, 3.8, or about 4.0)

Once the reactive group-terminated polymeric chain is formed, it can be contacted with a suitable difunctional compound under conditions suitable for forming the macromonomer. In some embodiments, the polymerizable group of the macromonomer is a carbon-carbon double bond (i.e., an alkenyl group). Thus, in some embodiments, the difunctional compound comprises at least one functional group that can react to form a covalent bond with an amino or hydroxyl group of a reactive group-terminated polymeric chain and also comprises a carbon-carbon double bound. In some embodiments, the difunctional compound includes a carbon-carbon double bond and at least one carboxylic acid or derivative thereof that can be coupled to the reactive group of the reactive group-terminated polymeric chain to form an ester or an amide linkage. In some embodiments, the difunctional compound is an alkenyl compound that is also a monocarboxylic acid or derivative thereof or a dicarboxylic acid or derivative thereof. In some embodiments, the difunctional compound can react with two equivalents of the reactive group-terminated polymeric chain to form a double-tailed macromonomer. For instance, in some embodiments, the difunctional compound is a dicarboxylic acid or derivative thereof, such as a diacyl halide or a cyclic anhydride that further comprises an alkenyl group. Alternatively, in some embodiments, the difunctional compound can react with one equivalent of a reactive group-terminated polymeric chain to form a single-tailed macromonomer. In some embodiments, the difunctional compound is selected from the group including, but not limited to, 4-vinyl benzoic acid, maleic anhydride, fumaric acid, fumaric acid chloride, maleic acid chloride (i.e., maleoyl dichloride), and maleic acid. In some embodiments, the difunctional compound is maleic anhydride or maleic acid, and the method provides a macromonomer comprising two polymeric chains attached to a polymerizable functional group (i.e., a double-tailed macromonomer).

In some embodiments, contacting the reactive group-terminated polymeric chain with the difunctional compound can be performed under conditions suitable for Steglich esterification or under similar conditions suitable for the formation of an amide bond. Thus, in some embodiments, the reactive group-terminated polymeric chain can be contacted with the difunctional compound in the presence of a carbodiimide, such as, but not limited to dicyclohexylcarbodiimide (DCC), diisopropylcarbodiimide (DIC) or 1-ethyl-3-(3-dimethylaminopropyl)carbodiimide (EDC), and a nucleophilic catalyst, e.g., dimethylaminopyridine (DMAP). In some embodiments, an activating compound, such as H-hydroxysuccinimide (NHS), N-hydroxysulfosuccinimide (sulfo-NHS), N-hydroxybenzotriazole (HOBt), or 1-hydroxy-7-azabenzotriazole (HOAt) can also be added, e.g., to react with a carboxylic acid group or a derivative thereof (e.g., an acyl chloride) to form an active ester susceptible to nucleophilic attack by the reactive group of the reactive group-terminated polymeric chain.

In some embodiments, the contacting is performed in a non-polar, aprotic solvent, such as dichloromethane (DCM) or tetrahydrofuran (THF). The contacting can be done at any suitable temperature. In some embodiments, the temperature is between about 40° C. and about −10° C. In some embodiments, the temperature is between about 25° C. and about −10° C. In some embodiments, the temperature is about room temperature (e.g., between about 25° C. and about 20° C.). In some embodiments, the temperature is between about 5° C. and about −10° C. In some embodiments, the temperature is about 0° C.

In some embodiments, such as when a double-tailed macromonomer is being formed, at least two molar equivalents of the reactive group-terminated polymeric chain are reacted with the difunctional compound. In some embodiments, between about 2.0 and about 2.5 molar equivalents (e.g., about 2.0, 2.1, 2.2, 2.3, 2.4, or 2.5 molar equivalents) of the reactive group-terminated polymeric chain are used (i.e., relative to the amount of difunctional compound used). In some embodiments, the reactive group-terminated polymeric chain is added to a solution prepared from the difunctional compound, the carbodiimide and the catalyst. In some embodiments, the full amount of reactive group-terminated polymeric chain is added all at one time. In some embodiments, the reactive group-terminated polymeric chain is added portion-wise, e.g., one equivalent at a time.

The esterification or amide forming reaction can be allowed to continue for any suitable amount of time, e.g., between about 30 minutes and about 50 hours. Once the esterification or amide forming reaction is complete (or after a suitable amount of time), the macromonomer can be isolated (e.g., via filtration and/or precipitation and/or via a chromatographic technique) and dried.

In some embodiments, the macromonomer has a number average molecular mass (Mₙ) of at least about 3,000 g/mol. In some embodiments, the macromonomer is relatively monodisperse (e.g., can have a PDI of less than 1.5). In some embodiments, the macromonomer has a PDI of between about 1.5 and about 4.0 (e.g., about 1.5, 1.6, 1.7, 1.8, 1.9, 2.0, 2.2, 2.4, 2.6, 2.8, 3.0, 3.2, 3.4, 3.6, 3.8, or about 4.0).

The macromonomers prepared via free radical solution or emulsion polymerization can then be contacted with at least a second monomer (i.e., with a second monomer or with a mixture comprising a second monomer and at least one or more additional monomers) and copolymerized to provide a multigraft copolymer (e.g., a random multigraft copolymer). The copolymerization can be performed via any suitable approach. However, in some embodiments, e.g., to keep the overall synthesis of the multigraft copolymer low cost and suitable for large scale production, the macromonomers prepared via free radical polymerization as described herein can be then be used in a free radical copolymerization with at least a second monomer to form a multigraft copolymer. Accordingly, in some embodiments, the presently disclosed subject matter provides a method of preparing multigraft copolymers (e.g., random multigraft copolymers) using solution or emulsion copolymerization (e.g., free radical mini-emulsion copolymerization) of monomers and macromonomers prepared using emulsion free radical polymerization. Therefore, in some aspects, the presently disclosed method relates to the use of the “grafting through” strategy of preparing graft copolymers in combination with emulsion copolymerization.

In some embodiments, the presently disclosed subject matter provides a method of preparing a multigraft copolymer (e.g., a random multigraft copolymer). In some embodiments, the method comprises: (a) providing a macromonomer via radical polymerization (such as via a method as described hereinabove), wherein said macromonomer comprises one or more polymeric chains attached to a polymerizable group, wherein the one or more polymeric chains comprise constitutional units from at least a first monomer; (b) contacting the macromonomer with at least a second monomer; and (c) copolymerizing the macromonomer and the second monomer to form the multigraft copolymer.

In some embodiments, the polymerizable group is a carbon-carbon double bond. In some embodiments, the first monomer comprises a vinyl group. In some embodiments, the first monomer can be polymerized to form a glassy or semi-crystalline polymeric chain. Suitable first monomers include, but are not limited to, styrenes, α-methylstryrene, alkenes (e.g., ethene (also known as ethylene)), methyl methacrylate, acrylonitrile, dienes (e.g., butadiene, cyclohexadiene, etc.), vinylhalides, and vinyl pyridine. In some embodiments, the first monomer is styrene.

In some embodiments, the macromonomer can have one, two, three, four, or more polymeric chains. In some embodiments, the macromonomer has one polymeric chain (i.e., is a “single-tailed” macromonomer). In some embodiments, the macromonomer has two polymeric chains (i.e., is a “double-tailed” macromonomer).

In some embodiments, providing the macromonomer comprises preparing a hydroxyl- or amino-terminated polymeric chain via radical polymerization (e.g., in an emulsion) and acylating one or more of said chains by esterification or amide formation between the reactive terminal group of the polymeric chain and a compound comprising both a polymerizable group and one or more carboxylic acid groups or carboxylic acid group derivatives. Esterification, for example, can be performed using a carbodiimide, such as, but not limited to dicyclohexylcarbodiimide (DCC) or diisopropylcarbodiimide (DIC), and dimethylaminopyridine (DMAP), i.e., Steglich esterification.

In some embodiments, the second monomer is an alkene, a diene, a vinyl halide, or a vinyl ester. In some embodiments, the second monomer can be a monomer such as, but not limited to, an alkyl methacrylate (e.g., methyl methacrylate). In some embodiments, the second monomer can polymerize to form a rubbery polymeric chain. In some embodiments, the second monomer is selected from the group including, but not limited to, an alkyl acrylate (e.g., n-butyl acrylate), isoprene, butadiene, ethylene, propylene, isobutylene, chloroprene (i.e., 2-chloro-1,3-butadiene), and mixtures thereof. In some embodiments, the second monomer is isoprene, butadiene, or an alkyl acrylate (e.g., n-butyl acrylate).

In some embodiments, the copolymerizing comprises radical polymerization and the macromonomer and second monomer are copolymerized in the presence of a radical initiator. In some embodiments, the copolymerizing is performed in an emulsion. The emulsion can comprise the macromonomer, second monomer, and radical initiator, as well as two immiscible liquids (e.g., an organic solvent and an aqueous solution) and one or more surfactants. Anionic, neutral or cationic surfactants can be used. In some embodiments, the emulsion can also include one or more co-surfactants, non-surfactant stabilizers (e.g., a water soluble polymer, such as polyvinyl alcohol), buffering agents, chain transfer agents, inert salts, and/or preservatives. In some embodiments, the polymerization is initiated by a thermally activatable initiator and/or a redox initiator.

Suitable thermally activatable radical initiators can include, for example, those of the peroxy and azo type. These include, but are not limited to, hydrogen peroxide, peracetic acid, t-butyl hydroperoxide, di-t-butyl peroxide, dibenzoyl peroxide, benzoyl hydroperoxide, 2,4-dichlorobenzoyl peroxide, 2,5-dimethyl-2,5-bis(hydroperoxy)hexane, perbenzoic acid, t-butyl peroxypivalate, t-butyl peracetate, dilauroyl peroxide, dicapryloyl peroxide, distearoyl peroxide, dibenzoyl peroxide, diisopropyl peroxydicarbonate, dodecyl peroxydicarbonate, dieicosyl peroxydicarbonate, di-t-butyl perbenzoate, azobisisobutyronitrile (AIBN), 2,2′-azobis-2,4-dimethylvaleronitrile, ammonium persulfate, potassium persulfate, sodium persulfate and sodium perphosphate.

Redox initiators can involve the use of a plurality of initiator components. For instance, redox initiation typically involves the use of an oxidizing agent (or agents) and a reducing agent, at least one of which is soluble in water. Suitable oxidizing agents include, for example, persulfate salts and hydroperoxides. Suitable reducing agents include, but are not limited to, glucose and sulfites. In some embodiments, redox initiation includes the use of a redox catalyst, such as an iron compound. A suitable redox initiator can include a combination of cumene hydroperoxide, iron sulfate, ethylenediaminetetraacetic acid (EDTA), and sodium formaldehyde sulfoxylate (SFS). In some embodiments, the initiator is AIBN. In some embodiments, the initiator is a combination of cumene hydroperoxide, iron sulfate, EDTA sodium salt, and SFS.

In some embodiments, the emulsion includes an anionic and/or nonionic surfactant. Anionic surfactants include, but are not limited to, sodium lauryl sulfate, sodium tridecyl ether sulfate, dioctylsulfosuccinate sodium salt and sodium salts of alkylaryl polyether sulfonates (e.g., sodium dodecylbenzene sulfonate, SDBS). Nonionic surfactants include, but are not limited to, alkylaryl polyether alcohols and ethylene oxide-propylene oxide copolymers. In some embodiments, the surfactant is SDBS.

In some embodiments, preparing the emulsion comprises adding the macromonomer and the second monomer to an organic solvent to prepare a homogeneous solution; adding the homogeneous solution to an aqueous solution comprising one or more surfactants to provide a mixture; and agitating the mixture to provide a homogeneous emulsion, wherein preparing the emulsion further comprises adding a polymerization initiator (or initiator component) to one or both of the homogeneous solution or the mixture. In some embodiments, the organic solvent is a non-polar organic solvent, such as an aromatic solvent or an alkane (e.g., toluene or hexadecane). The agitating can be performed by any suitable approach, e.g., sonication, high-pressure homogenizer, manual or robotic shaking, etc. In some embodiments, the homogeneous emulsion comprises stable nanoparticles of the dispersed phase (e.g., the organic phase). The nanoparticles can have a diameter of between about 50 nanometers and about 1 micron, or between about 50 nanometers and about 500 nanometers.

In some embodiments, copolymerizing the macromonomer and the second monomer comprises heating the emulsion. The heating can be to between about 40° C. and about 100° C. (e.g., about 40, 45, 50, 55, 60, 65, 70, 75, 80, 85, 90, 95 or about 100° C.). In some embodiments, the heating is to between about 50° C. and about 90° C. In some embodiments, the heating is to about 60° C. or to about 80° C.

The copolymerizing can continue for any desired length of time (e.g., to provide a desired copolymer weight or monomer conversion level). In some embodiments, samples of copolymer can be taken during the polymerization to allow for characterization of the remaining monomers and the copolymers by absolute molecular weight methods such as osmometry, matrix assisted laser desorption ionization time-of-flight mass spectrometry (MALDI-TOF-MS), and light scattering, as well as by gel permeation chromatography (GPC), size exclusion chromatography, nuclear magnetic resonance (NMR) spectrometry, and infrared (IR) spectrometry. In some embodiments, the copolymerization can continue for between about 1 hour and about 24 hours (e.g., 1, 2, 3, 4, 5, 6, 7, 8, 9, 10, 11, 12, 13, 14,15, 16, 17, 18, 19, 20, 21, 22, 23, or 24 hours). In some embodiments, the copolymerization can continue for between about 6 hours and about 12 hours. In some embodiments, the copolymerization can continue for about 8 hours. Copolymerization can be stopped by demulsification, such as by adding a salt (e.g., sodium chloride) to break the emulsion.

In some embodiments, the copolymers can be dissolved in an organic solvent (e.g., THF) and precipitated into an alcohol (e.g. methanol). If desired, the copolymer can be dried. The drying can be done under vacuum, with or without heating (e.g., to about 30° C., 35° C. or 40° C.). In some embodiments, the copolymers can be purified, e.g. to remove any remaining macromonomer. Purification can be performed by any suitable technique, such as, but not limited to, via fractionation. Thus, in some embodiments, the presently disclosed methods can further include drying and/or purifying the copolymers.

In some embodiments, the prepared copolymers can have a latex particle size of about 250 nm or less. In some embodiments, the particle size can be between about 30 nm and about 150 nm (e.g., about 30, 40, 50, 60, 70, 80, 90, 100, 110, 120, 130, 140, or about 150 nm). In some embodiments, the particle size is between about 50 nm and about 120 nm.

### III. Compositions Comprising Multigraft Copolymers

In some embodiments, the multigraft copolymers prepared according to the presently disclosed methods can have relatively high molecular weight and/or a relatively high number of grafts, e.g., as compared to multigraft copolymers prepared using anionic polymerization. In some embodiments, the presently disclosed methods can provide copolymers with a number average molecular weight (Mₙ) that is greater than about 850,000 g/mol. In some embodiments, the Mₙ is about 1,000,000, about 1,100,000 or about 1,200,000 g/mol or greater. In some embodiments, the presently disclosed methods can provide copolymers with at least about 15 branch points per molecule (e.g., about 15, 16, 17, 18, 19, 20, 21, or 22 branch points per molecule).

In some embodiments, the presently disclosed methods can be used to prepare multigraft copolymers having elastic or adhesive properties. For instance, multigraft copolymers with a “rubbery” backbone, such as polyisoprene (PI) or other polymers having a glass transition temperature (T_{g}) of about 0° C. or less, and “glassy” side chains, such as polystyrene (PS) or other polymers having a T_{g} of about 60° C. or more, can provide a class of thermoplastic elastomers that can be referred to as “superelastomers.” Superelastomers can have advantageous properties compared to commercial linear thermoplastic elastomers, such as larger elongation at break, lower residual strain, and highly tunable modulus. One aspect of the presently disclosed subject matter is the finding that multigraft copolymers prepared using macromonomers synthesized via radical polymerization or prepared completely via radical polymerization (and which can, in some embodiments, have higher PDI and/or morphology with poorer long range order than multigraft copolymers prepared via anionic polymerization or using macromonomers prepared via anionic polymerization) can still be superelastomers.

Thus, in some embodiments, the methods are used to prepare a multigraft copolymer (e.g., a random multigraft copolymer) that comprises a rubbery polymeric backbone and a plurality of glassy polymeric grafts, each attached at one of a plurality of randomly placed branch points on the polymeric backbone. The multigraft copolymer can comprise, for example a trifunctional comb architecture, in which a single graft is attached at each branch point, a tetrafunctional centipede architecture, in which two grafts are attached at each branch point, or a hexafunctional barbwire architecture, in which four grafts are attached at each branch point.

As used herein, “rubbery” refers to a polymer that has a glass transition temperature of about 0° C. or less (e.g., about 0, −10, −20, −30, −40, −50, −60, −70, −90, −100° C. or less). In some embodiments, the rubbery polymer backbone can comprise one of the polymers including, but not limited to, polyisoprene, hydrogenated polyisoprene, polybutadiene, hydrogenated polybutadiene, polyisobutylene, butyl rubber, poly(butadiene-co-acrylonitrile), a silicone rubber (e.g., polydimethylsiloxane or another siloxane polymer), acrylic rubber, polychloroprene, ethylene propylene copolymer, ethylene/acrylic elastomer, urethane rubber, and combinations thereof. Thus, in some embodiments, the second monomer can be selected from monomers suitable for preparing such rubbery backbones (e.g, monomers including one or more of the group comprising isoprene, butadiene, isobutylene, acrylonitrile, an alkyl acrylate, dimethyldihalosilane, chloroprene, ethylene, and propylene).

As used herein, “glassy” refers to a polymer that has a glass transition temperature of about 60° C. or more (e.g., about 60, 70, 80, 90, or 100° C. or more). As used herein “glassy” can include semi-crystalline polymers (e.g., having a melting point of about 60° C. or greater). In some embodiments, the glassy polymer grafts can comprise a polymer selected from, but not limited to, polystyrene, hydrogenated polystyrene, poly(α-methylstyrene) or another glassy styrenic polymer hydrogenated derivative thereof, polyethylene, urethane hard domain, polyester, polymethylmethacrylate or another glassy acrylic polymer, polyvinyl chloride, poly(vinyl pyridine), polycarbonate, nylon, polyethylene teraphthalate, polycyclohexadiene, hydrogenated polycyclohexadiene, and combinations thereof. Thus, the first monomer can be selected from suitable monomers for the preparation of such glassy polymers.

In some embodiments, the weight percentage of the glassy grafts is between about 5 weight % and about 50 weight % (e.g., about 5, 10, 15, 20, 25, 30, 35, 40, 45, or 50 weight %) of the copolymer. In some embodiments, the weight % of the glassy grafts is between about 9 weight % and about 43 wieght %. In some embodiments, the weight % of the glassy grafts is between about 9 weight % and about 32 weight %. In some embodiments, the weight % of the glassy grafts is between about 5 weight % and about 15 weight % or less.

In some embodiments, the glassy segments comprise polystyrene. In some embodiments, the rubbery backbone is polyisoprene or poly(n-butyl acrylate). In some embodiments, the first monomer is styrene and the second monomer is n-butyl acrylate. In some embodiments, the first monomer is styrene and the second monomer is isoprene.

In view of the mechanical properties of the presently disclosed materials, compositions comprising the materials can be provided for use in a wide variety of areas, both as high-tech and commodity thermoplastics. In particular, it is believed that the random multigraft copolymers disclosed herein can be prepared readily in large amounts and at relatively low cost, while still providing materials having high tensile strength, high elasticity, and high strain at break.

Accordingly, in some embodiments, the presently disclosed subject matter provides a thermoplastic elastomer composition comprising a random multigraft copolymer comprising a copolymer prepared using emulsion copolymerization and a macromonomer prepared via radical polymerization via a method as disclosed herein and comprising a rubbery polymeric backbone and a plurality of glassy polymeric grafts, wherein each of the plurality of glassy polymeric grafts is attached to the rubbery polymeric backbone at one of a plurality of randomly spaced branch points. The composition can also include at least one additional component, such as, but not limited to, an organic filler, an inorganic filler, a wax, a plasticizer, a tackifier, an anti-oxidant, a stabilizer (e.g., a thermal or UV stabilizer), a decorative agent, a biocide, a flame retardant, an anti-static agent, a therapeutic agent, a processing aid, such as a lubricant or a mold-release agent, and combinations thereof. More particular additives that can be used are described, for example, in U.S. Patent Application Publication No. 2014/0161858, herein incorporated by reference in its entirety. The type and amount of an additive or additives can be chosen based on the properties desired for the final end use of the composition. The additive or additives can be present in an amount that is less than about 50% by volume or by weight of the composition as a whole. Alternatively, the multigraft copolymer can comprise less than about 50% of the composition as a whole.

The presently disclosed compositions can obtained by mixing and homogenizing the components by the usual methods of plastics technology, and the sequence of adding the components can be varied. Examples of suitable mixing equipment are continuous or batch kneaders, compounding rolls, plastographs, Banbury mixers, co-rotating or counter rotating single- or twin-screw extruders, or other mixers which will provide essentially homogeneous mixtures. In some embodiments, the presently disclosed compositions are prepared by blending together the components including the multigraft copolymer and other additive or additives as desired at between about 23° C. to about 100° C., forming a paste like mixture, and further heating said mixture uniformly (e.g., to about 150° C., or to about 200° C. or more) until a homogeneous molten blend is obtained. Any heated vessel equipped with a stirrer can be used, including those equipped with components to pressure and/or vacuum.

The thermoplastic properties of the presently disclosed copolymers and compositions lend themselves to the fabrication of a variety of articles, via molding and other methods of fabrication known in the art, including, but not limited to injection molding, compression molding, extrusion, and calendaring. Accordingly, in some embodiments, the presently disclosed subject matter provides a fabricated article comprising a random multigraft copolymer. The fabricated articles can be for example an automotive interior or exterior part (e.g. an air bag or air bag door, a seat covering (such as artificial leather upholstery), bumpers, decorative molding pieces, etc.); shoe soles or other shoe parts; elastic waistbands; diaper or sanitary napkin backings or attachments; adhesive tapes, membranes, toys (or parts for toys), balloons, bags, tubing, roofing tiles, medical devices, and electronic wiring coatings or other electronic device components. For example, U.S. Patent Application Publication No. 2009/0028356, herein incorporated by reference in its entirety, describes the use of elastomeric polymers as an expandable bubble portion in an audio device. In some embodiments, the compositions can be used to provide elastic or flexible moldings for “soft-touch” applications, such as grips, handles, antislip surfaces, gaskets, switches, housings with sealing lips, control knobs, flexographic printing plates, hoses, profiles, medical items, hygiene items, such as toothbrushes, materials for insulating or sheathing cables, sound-deadening elements, folding bellows, rolls or roll coatings, and carpet backings.

In some embodiments, the article is a medical device. Medical devices can include, but are not limited to, infusion kits, dialysis units, breathing masks, catheter tubing, intravenous (iv) bags or tubing therefore, blood bags, syringes, prosthetics, prophylactics, implants or implant coverings (e.g. orthopedic implants, stents or other endoprostheses, or coverings for pacemakers or cochlear implants). In some embodiments, the article is a balloon catheter or a stent. For example, the article can comprise a balloon catheter wherein at least the inflatable portion of the balloon catheter comprises the presently disclosed thermoplastic elastomer composition. Catheters can include any tubing (e.g., flexible or “soft” tubing) that can be inserted into a body cavity, duct, or vessel to inject or to drain fluids. The body cavity, duct, or vessel can be for example, the urethra, the bladder, a blood vessel (e.g., a vein or artery), a biliary duct, the kidney, the heart, the uterus, a fallopian tube, the epidural space, the subarchnoid space, etc. The balloon catheter can be inserted into the body to deliver a stent. For example, the stent can be placed over the balloon portion of the catheter for insertion into the body. When placed inside the body at the desired location (e.g., in a blocked artery), the balloon can be inflated, thereby expanding the stent. The balloon can then be deflated and the catheter removed, leaving the stent in position within the body.

Stents can have one or more branch points. For example, stents can be y-shaped, including a central main tube portion that at one end is separated into two tubes. Stents can be fabricated from metal, polymers, or combinations thereof. For example, the stent can include a wire mesh, a metal coil or coils, or metal rings covered by and/or connected with the presently disclosed composition. Alternatively, the stent can comprise the presently disclosed composition alone or as a covering for another polymeric material.

The stent can be coated with a drug-eluting coating or the thermoplastic elastomeric composition can include a therapeutic additive which can elute from the composition upon placement in the body or upon exposure to particular conditions (e.g., heat, pH, enzymes, etc.). For example, the multigraft copolymer can be blended with a biodegradable polymer having an encapsulated or otherwise complexed drug.

In some embodiments, the presently disclosed compositions are provided for use as adhesive materials. The adhesive can be a pressure sensitive adhesive or a hot melt adhesive and can be used, for example, to adhere plastics to other plastics or to other materials (e.g., paper, wood, metal, glass, etc.). The adhesive composition can include a tackifier. The adhesive can further comprise one or more other additives, such as, but not limited to, waxes, plasticizers, anti-oxidants, UV-stabilizers, decorative agents, biocides, flame retardants, anti-static agents, and fillers. The adhesive can be formulated to provide either temporary or permanent adhesion.

The presently disclosed adhesive compositions can be used, for example, to act as a releasable adhesive for holding gift cards or other plastic cards onto paper or other backings for temporary display or presentation purposes. The presently disclosed adhesive compositions can also be provided in the form of adhesive tapes, comprising one or more releasable backing components that can be easily removed just prior to use of the adhesive. The compositions can further be provided as adhesive backings on other materials, e.g., labels, stamps, automotive trim, bandages or other wound care items, drug patches, diapers, etc. In some embodiments, the adhesive compositions can be provided in the form of spheres, bars or rods suitable for use as hot-melt adhesives, in the home, e.g., for various arts or crafts projects, or in industry, e.g., for the construction of cardboard boxes or for the fabrication of sporting equipment or toys.

The presently disclosed compositions are also useful as elastic or flexible coating layers over other objects, particularly for “soft-touch” applications. “Soft touch” applications include those, for instance, for which one or more of a soft texture, shock absorption, ergonomic comfort, slip resistance, and flexibility, are desirable.

Thus, in some embodiments, the presently disclosed subject matter provides a coated object comprising a coating layer comprising a random multigraft copolymer prepared according to the presently disclosed methods, wherein the random multigraft copolymer comprises a rubbery polymeric backbone and a plurality of glassy polymeric grafts, wherein each of the plurality of glassy polymeric grafts is attached to the rubbery polymeric backbone at one of a plurality of randomly spaced branch points, wherein the coating layer covers at least a portion of a surface of a wood, ceramic, glass, carbon fiber, metal, metallic, leather, fabric, stone, or plastic object. In some embodiments, the object is selected from the group comprising an article of clothing (e.g., a shoe or a portion of a shoe, such as a shoe sole, for orthopedic, athletic, or children's shoes or for work boots), an eating or cooking utensil (e.g., baby spoons or other infant feeding tools where a soft mouth feel might be needed, knives, tongs, vegetable peelers, etc), tools (e.g., hammers, wrenches, screwdrivers, saws, etc.), medical implants (e.g. stents, pacemakers, cochlear implants), medical/surgical tools (e.g., retractors, scalpels, clamps, etc.) and wiring and electronic devices (e.g. electronic wiring or fiber optic wiring, materials in ear buds).

In some embodiments, the copolymer has a number average molecular mass (Mₙ) greater than about 50,000 grams per mole (g/mol) or more (e.g., about 50,000, about 60,000, about 70,000, about 80,000, about 90,000, about 100,000, about 125,000, about 150,000, about 175,000, about 200,000, about 250,000, about 300,000, about 350,000, about 400,000, about 450,000, or about 500,000 g/mol). In some embodiments the copolymer has a Mₙ of about 500,000 grams per mole (g/mol) or greater (e.g., about 550,000, about 600,000, about 700,000, about 800,000, about 900,000, about 1,000,000 g/mol, about 1,100,000, about 1,200,000, or about 1,300,000 g/mol or greater). In some embodiments, the Mₙ is about 750,000 g/mol or greater. In some embodiments, the Mₙ is about 1,000,000 g/mol or more.

In some embodiments, the glassy or semi-crystalline polymeric side chains comprise polystyrene. In some embodiments, the copolymer comprises between about 5 and about 50 weight % polystyrene. In some embodiments, the copolymer comprises between about 15 and about 43 weight % polystyrene (e.g., about 15, 16, 17, 18, 19, 20, 21, 22, 23, 24, 25, 26, 27, 28, 29, 30, 31, 32, 33, 34, 35, 36, 37, 38, 39, 40, 41, 42, or 43 weight % polystyrene). In some embodiments, the copolymer comprises between about 15 and about 30 weight % polystyrene. In some embodiments, the copolymer comprises between about 26 and about 32 weight % polystyrene.

In some embodiments, the copolymer has a polydispersity index (PDI) that is about 3 or less. In some embodiments, the PDI is between about 2 and about 3. In some embodiments, the copolymer has a glass transition temperature (T_{g}) of between about −13° C. and about −42° C. In some embodiments, the Tg is between about −35 and about −42° C. (e.g., about −35, −36, −37, −38, −39, −40, −41, or −42° C.).

The random multigraft copolymer can have any number of branch points. In some embodiments, the copolymer has at least about 3 branch points per molecule. In some embodiments, the copolymer has at least about 5, at least about 7, at least about 10, or at least about 12 branch points per molecule. In some embodiments, the copolymer has between about 15 and about 22 branch points per molecule (e.g., about 15, 16, 17, 18, 19, 20, 21, or 22 branch points per molecule).

### IV. Morphology and Mechanical Properties

Variations in the molecular architecture of graft copolymers can be manipulated to control their nano-scale structure (morphology) and their ability to form long-range order during self-assembly. To provide a desired performance, the size, shape and symmetry, and overall volume fraction of different types of domains can be controlled independently. This independent control is not possible with conventional linear AB diblock copolymers and ABA triblock copolymers for which the nanophase separated morphology which forms (e.g., spheres, cylinders, cubic bicontinuous gyroid, or lamella) is tied directly to the relative volume fractions of the two block materials. Previous characterization data on complex graft copolymer architectures with multiple grafting points has been fit into the framework of a theoretical morphology diagram calculated by Milner, S. T., Macromolecules, 27, 2333 (1994).

Morphological characterization of the multigraft copolymers can utilize real-space, transmission electron microscope (TEM) imaging and reciprocal-space small angle scattering (SAXS and/or SANS) techniques.

Other things being equal (e.g., “glassy” polymer volume fraction and average number of grafts per molecule), in some embodiments of the presently disclosed subject matter, increasing junction point functionality increases material strength and elasticity. Additionally, for a fixed glassy polymer volume fraction and junction point functionality, in some embodiments of the presently disclosed subject matter, increasing the number of junction points per copolymer increases the strength, strain at break, and elasticity. In a representative comparison, the copolymers of the presently disclosed subject matter can compared to the strength, elasticity and strain at break performance of commercial thermoplastic elastomers, such as KRATON™ and STYROFLEX™ materials (Kraton Polymers, Houston, Tex., United States of America and BASF, Ludwigshafen, Germany, respectively) via tensile tests that utilize a scaled down ASTM standard “dog bone.”

If desired, in addition to tensile tests at room temperature, tensile performance at elevated temperatures can be evaluated, to determine material properties under conditions of any particular proposed use. Dynamical mechanical, creep, and fatigue performance of these materials at room and elevated temperatures can also be evaluated. Thermogravimetric analysis (TGA) can be used to investigate the chemical stability of the materials at elevated temperatures.

### EXAMPLES

The following examples are included to further illustrate various embodiments of the presently disclosed subject matter. However, those of ordinary skill in the art should, in light of the present disclosure, appreciate that many changes can be made in the specific embodiments which are disclosed and still obtain a like or similar result without departing from the spirit and scope of the presently disclosed subject matter.

### Example 1

### Synthesis of Hydroxyl End Functionalized Polystyrene (PS-OH) by Emulsion Polymerization

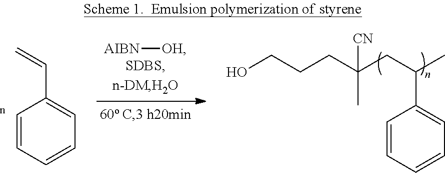

A hydroxyl functionalized radical initiator, i.e., 2,2′-(diazene-1,2-diyl)bis(5-hydroxy-2-methylpentanenitrile) (AIBN-OH) was used as the radical source to prepare polystyrene with a hydroxyl end-functionality by emulsion polymerization as shown in Scheme 1, above. In a typical reaction, 2.5 grams (g) of styrene and dodecyl mercaptan (n-DM, 0.0347 g, 0.17 millimoles (mmol)) was emulsified with 14.27 g of D.I. water for 20 minutes (min) with 0.1887 g of SDBS used as the surfactant. After being thermally equilibrated for 5 min at 60° C., the emulsion was charged with 0.2384 g (0.96 mmol) of AIBN-OH/THF (2 milliliters (ml)) mixture. After polymerizing for 200 mins, the emulsion was coagulated with NaCl (eq.) and precipitated in methanol (MeOH) two times. The resulting polymer (PS-OH) was filtered and dried for 24 hours (h), the yield was 63.98%.

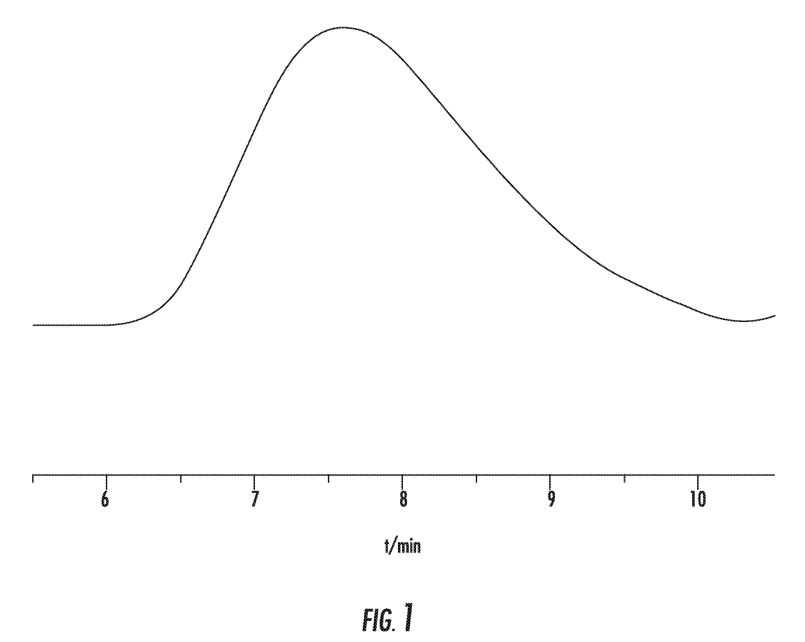

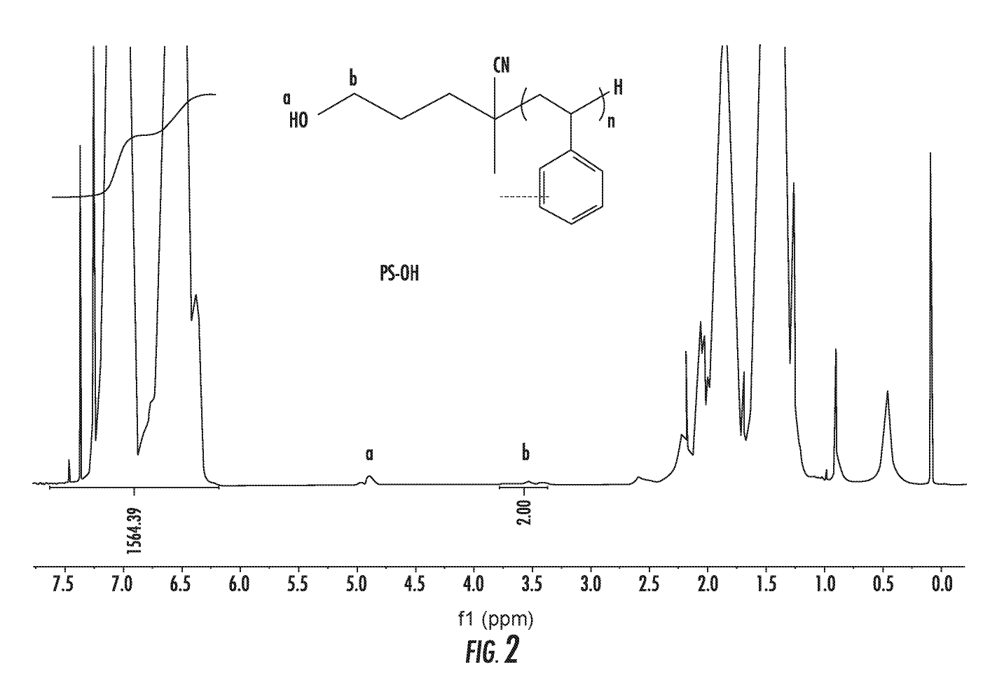

The molecular weight (MW) and polydispersity index (PDI) of PS-OH was measured by SEC with ultraviolet (UV) and refractive index (RI) detector in THF at 40° C. with flow rate of 1 ml/mol. See FIG. 1. The number average molecular mass (Mₙ) of PS-OH was 23 kilograms per mole (kg/mol) with a PDI of 2.55. The hydroxyl end functionality of PS-OH was characterized using ¹H-NMR. See FIG. 2. As shown in FIG. 2, the signal from the proton on the hydroxyl group was located at 4.75 parts-per-million (ppm) and the proton signal from the hydrogens on the carbon adjacent to hydroxyl group was located at 3.45 to 3.60 ppm.

### Example 2

### Synthesis of Single-Tailed PS Macromonomer

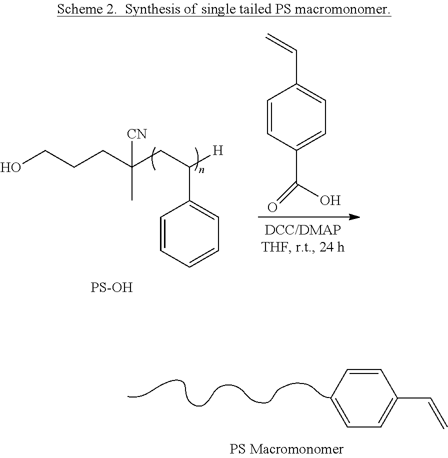

The singled tailed PS macromonomer was synthesized by DCC/DMAP coupling reaction between PS-OH and 4-vinyl benzoic acid as shown in Scheme 2, above. Generally, 0.0563 g of DCC in 7 ml of THF was added dropwise at 0° C. into mixture of PS-OH (1.4 g, 0.061 mmol), 4-vinyl benzoic acid (0.036 g, 0.273 mmol) and DMAP (0.0334 g, 0.273 mmol) in 20 ml of THF. After the reaction was allowed to proceed for 24 h, the solution was filtered and precipitated into MeOH. The resulting PS macromonomer was recovered by filtration and dried in a vacuum oven for 24 h.

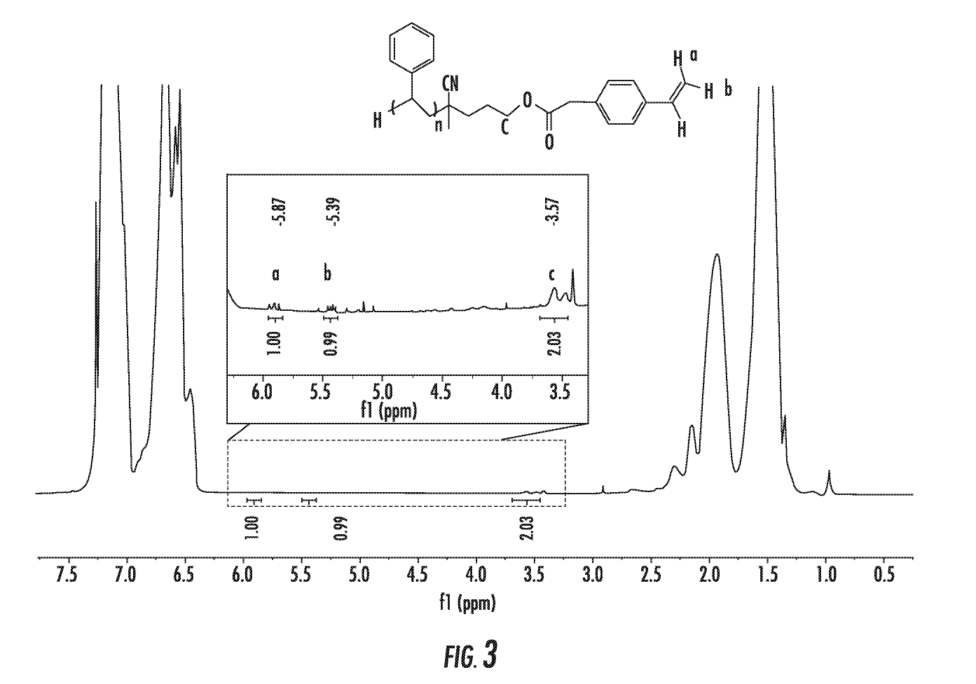

From the ¹H-NMR analysis, signals for Ha, Hb (for the terminal vinylic protons) and Hc (for the protons on the carbon adjacent to the ester oxygen) were located at 5.87 ppm, 5.39 ppm and 3.57 ppm. See FIG. 3. The integration ratio of these proton Ha:Hb:Hc=1:1:2, which indicated 100% of conversion from PS-OH to PS macromonomer.

### Example 3

### Synthesis of Double-Tailed PS Macromonomer

In order to prepare a double-tailed PS macromonomer, three different difunctional linking reagents: maleic anhydride (MAH), fumaric acid (FA), maleic acid (MA), and maleoyl dichloride can be employed. The PS-OH used in these reactions were synthesized by terminating an anionically synthesized PS lithium anion with ethylene oxide and acidic methanol, however PS-OH synthesized free radically as described above can be used in place of the anionically synthesized PS-OH.

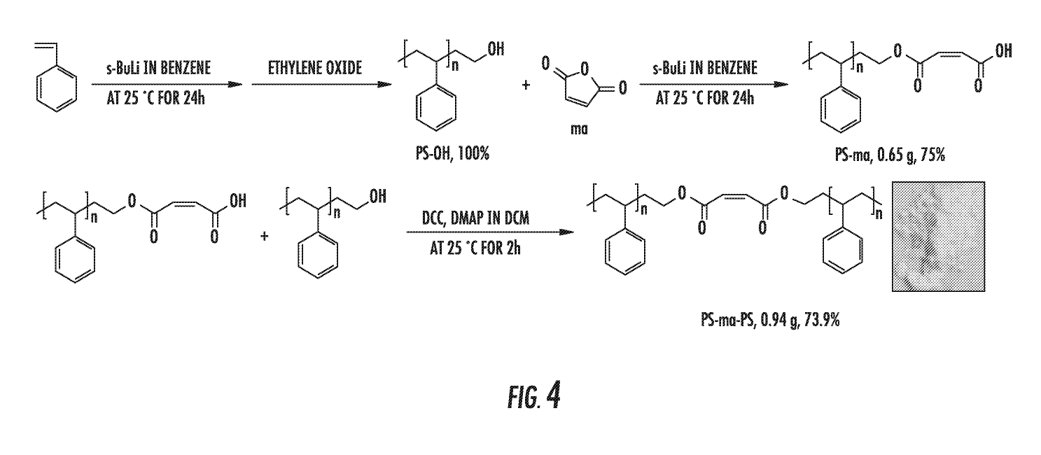

Method 1: When MAH was used as the linking reagent, 1 equivalent (eqv.) of PS-OH was added into MAH mixture with DCC and DMAP in dichloromethane (DCM) at 25° C. After 24 h, another 1 eqv. of PS-OH was added into the same mixture and reacted for another 24 h. See FIG. 4. The double tailed macromonomer PS-MAH-PS was recovered by filtration, precipitation into methanol, filtration and dried into vacuum over for 24 h. The yield was 73.9%.

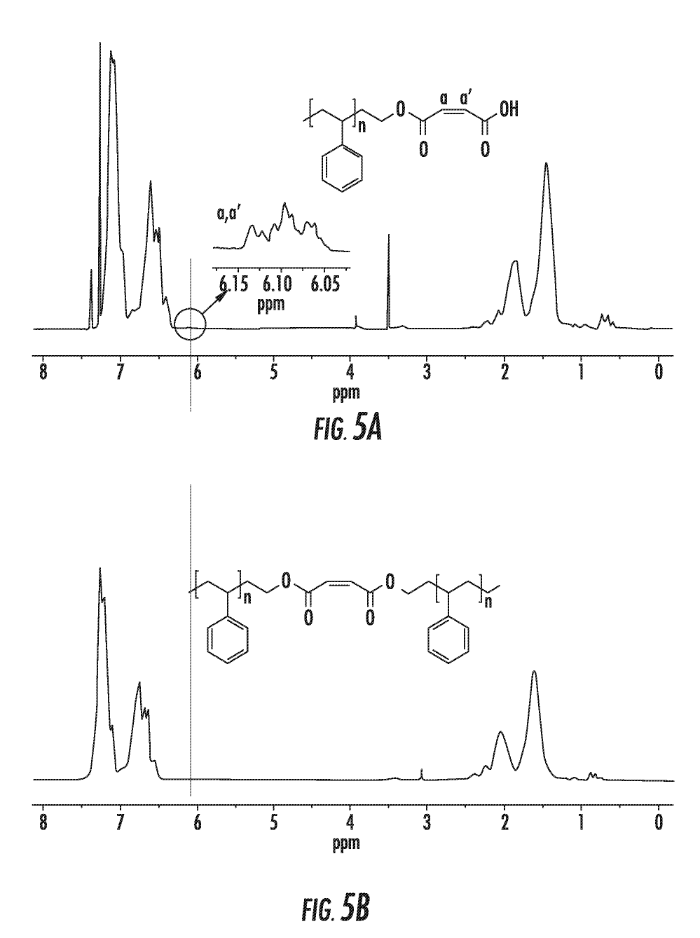

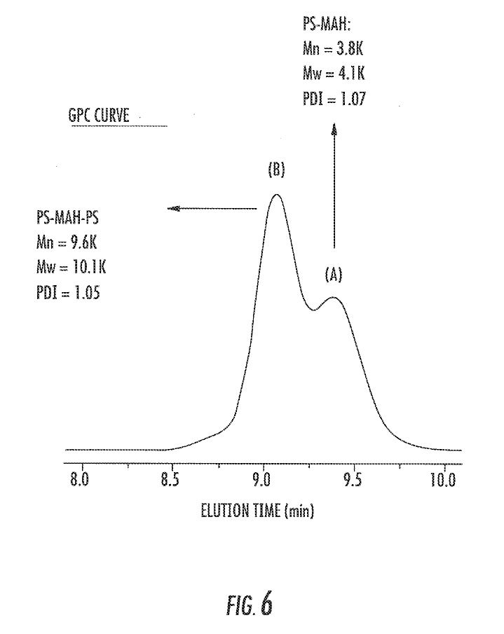

From ¹H-NMR analysis, the proton signal from 6.00 to 6.15 ppm is a clear indication of attachment of PS-OH to the maleic anhydride. See FIGS. 5A and 5B. SEC analysis indicates the as-recovered double-tailed macromonomer has 65% of PS-MAH-PS (Mₙ=9.6 kg/mol, PDI=1.05) with 35% of single tailed PS-MAH (Mₙ=3.8 kg/mol, PDI=1.07). See FIG. 6.

Method 2: When using fumaric acid (FA) as the difunctional linker, a similar DCC/DMAP coupling reaction procedure was used by adding 2.2 eqv. of PS-OH (8.5 kg/mol) into FA/DCC/DMAP mixture in dichloromethane. See FIG. 7. The reaction was allowed to proceed for 24 h, filtered, precipitated and dried in vacuum oven. The resulting macromonomer PS-FA-PS was characterized by both SEC and ¹H-NMR.

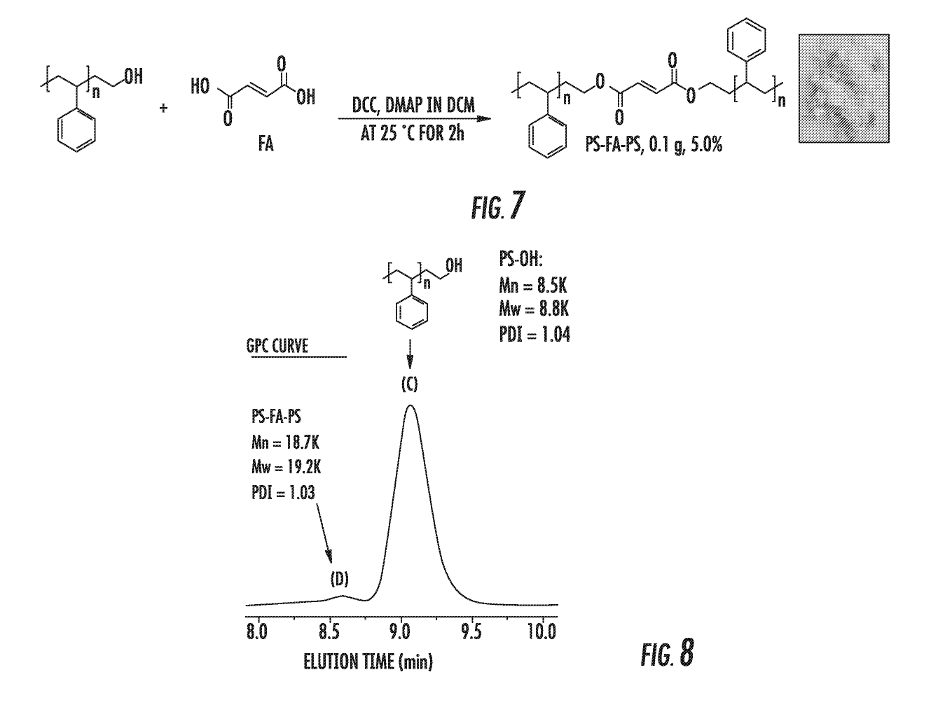

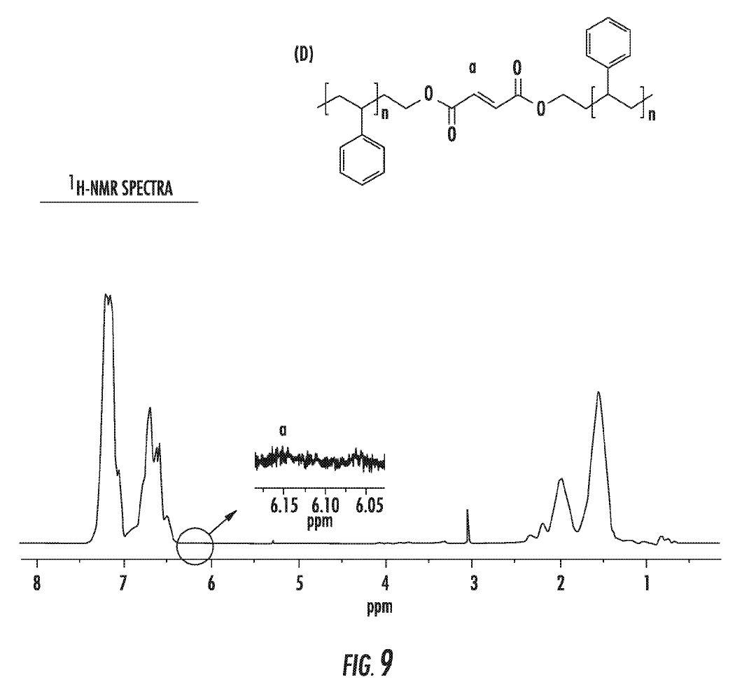

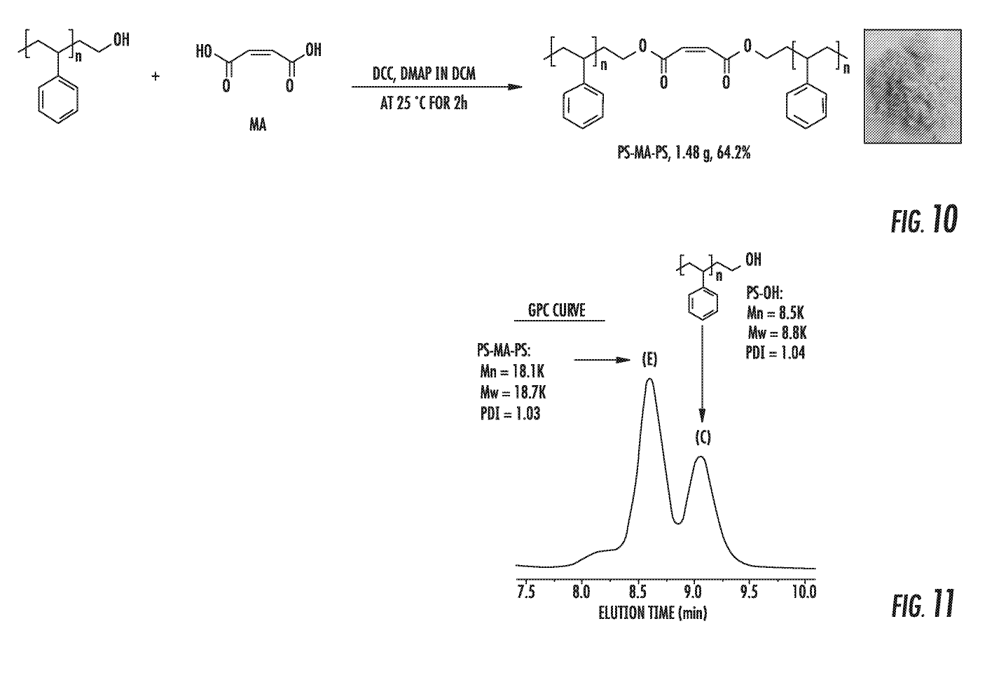

From SEC analysis, it appeared that less than 5% of double tailed macromonomer PS-FA-PS was present in the polymer mixture. See FIG. 8. This result was further confirmed by ¹H-NMR, where the signal corresponding to the proton on FA was relatively insignificant. See FIG. 9. Thus, it appears that the majority of the polymer in the mixture was unreacted PS-OH.

Method 3: When using maleic acid as the difunctional linker, 2.2 eqv. of PS-OH (8.5 kg/mol) was added into mixture of MA/DCC/DMAP in dichloromethane and reacted for 2 h at room temperature. See FIG. 10. The polymer was recovered by similar method as mentioned previously.

From SEC analysis, 64.2% of PS-MA-PS double tailed macromonomer was present in the polymer mixture. See FIG. 11. The Mₙ for PS-MA-PS was 18.1 kg/mol and PDI was 1.03 whereas the Mₙ for PS-OH was 8.5 kg/mol with PDI of 1.04.

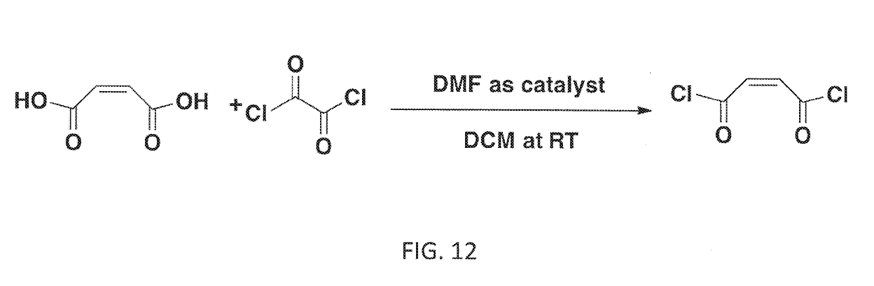

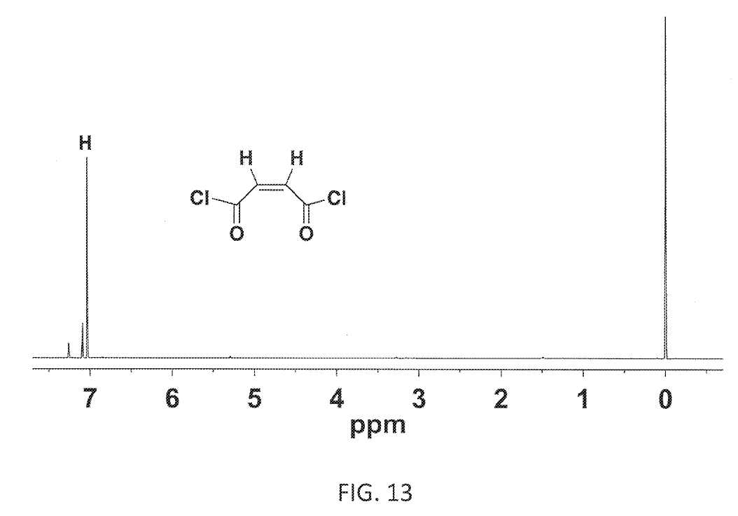

Method 4: As shown in FIG. 12, maleic acid (MA) (5 g, 38.4 mmol), oxalyl chloride (48.74 g, 384 mmol), and dichloromethane (DCM, 36 ml) were mixed together. Then, N,N-dimethylformamide (DMF) (40 μL) as a catalyst was carefully added at room temperature. The mixture was stirred for 10 min and then reflux at 60° C. for 6 h. A yellow heterogeneous solution was obtained. The brown solid product maleoyl dichloride (MC) was purified by removing solvent through distillation. The vinyl protons adjacent to carbonyl chloride groups were verified by ¹H-NMR at 7.04 ppm as shown in FIG. 13.

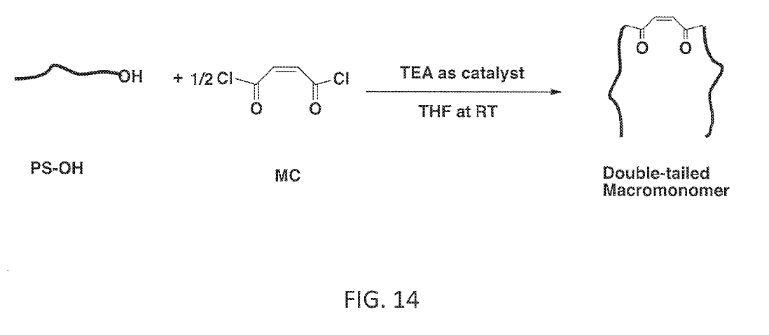

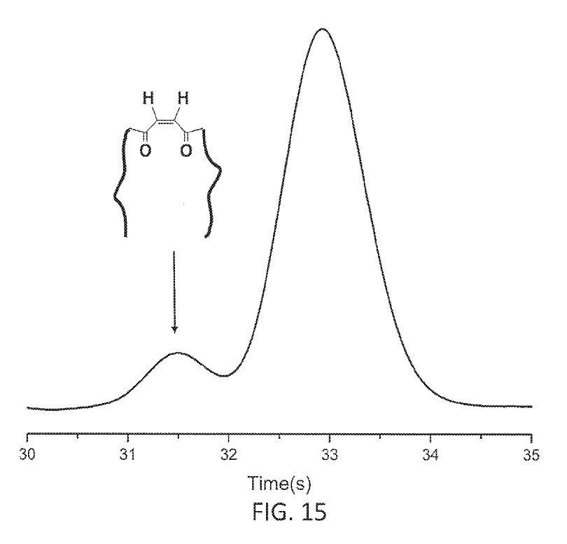

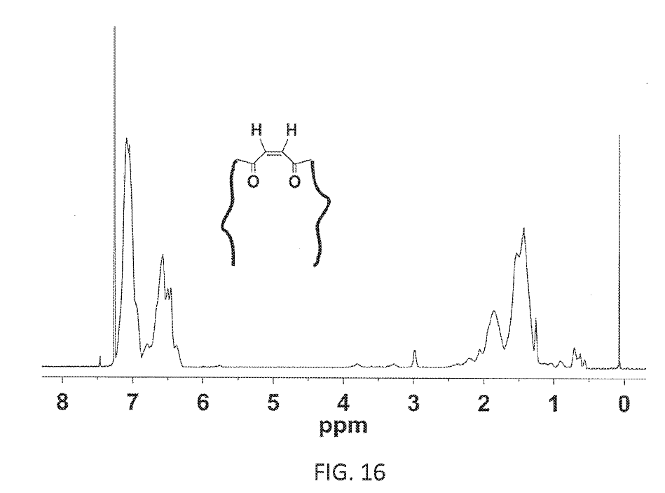

Double-tailed macromonomer was prepared using MC as shown in FIG. 14. Hydroxyl end-functionalized PS (PS-OH) (1.1 g, 4 kg/mol, 0.275 mmol) was dissolved in THF (12 mL) and purged with nitrogen. Triethylamine (TEA) (50 μL) was then added as a catalyst. The polymer solution was stirred in an ice-water bath for 10 min. Then 1 ml of stock solution of maleoyl dichloride (MC) in THF (19.1 mg/mL) was added to the mixture dropwise. The mixture was kept in the ice bath for another 30 min and then stirred at room temperature for 24 h. Molecular weight (Mn=8 kg/mol) of PS double-tailed macromonomer was obtained from GPC as shown in FIG. 15. The conversion of this reaction is 15% as calculated from ¹H-NMR using the vinyl proton peak present in macromonomer at 5.77 ppm in FIG. 16.

### Example 4

### Synthesis of Multigraft Copolymer by Free Radical Polymerization

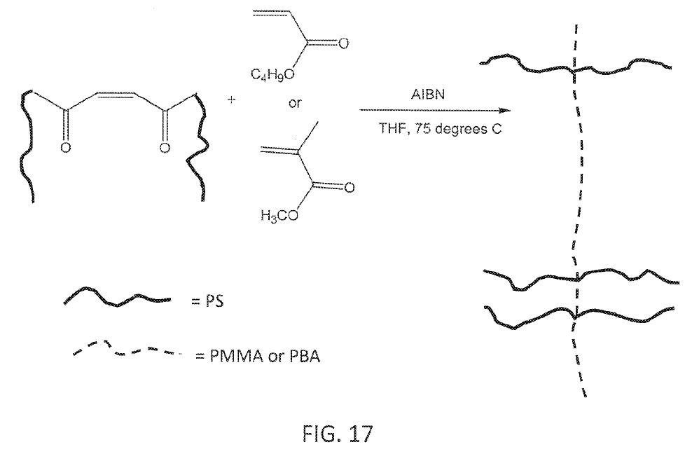

An exemplary synthesis of multigraft copolymers via copolymerization of macromonomers and monomers via free radical polymerization is shown in FIG. 17. As shown in FIG. 17, random multigraft copolymers were prepared by copolymerizing a double-tailed PS macromonomer with either methyl methacrylate or n-butyl acrylate. The random multigraft copolymers have centipede architecture.

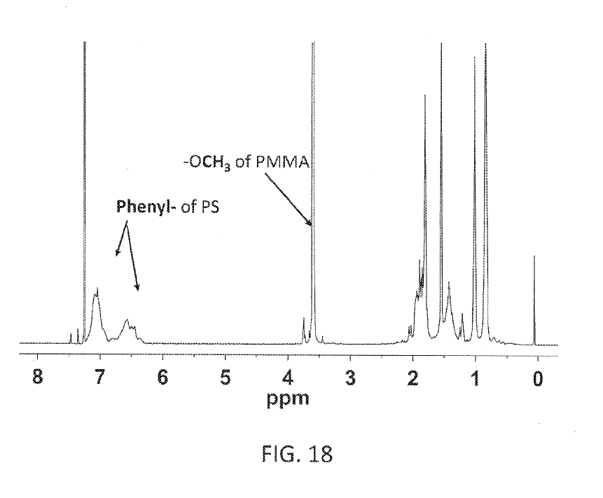

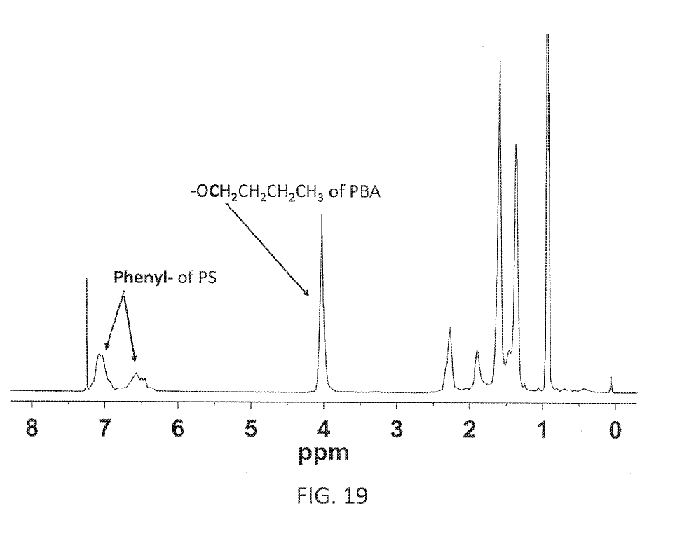

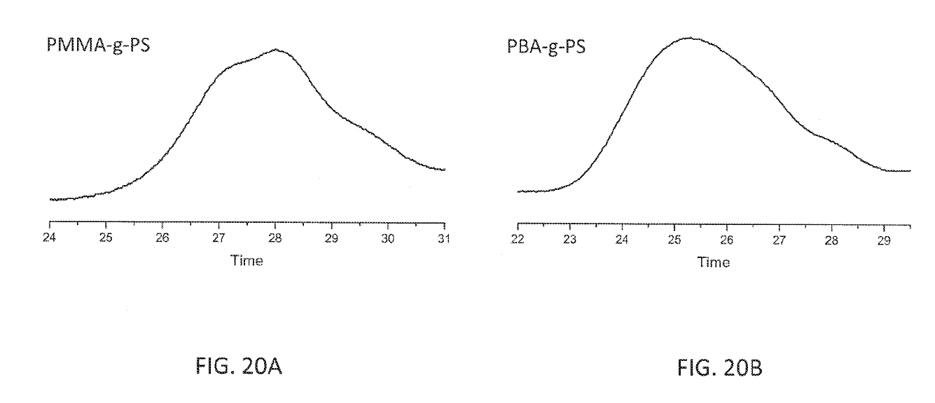

More particularly, PS macromonomers (0.5 g, 15% double-tailed macromonomer), n-butyl acrylate (1.5 g, 11.7 mmol), AIBN (20 mg, 0.122 mol), and benzene (1.5 mL) were mixed in a round-bottom flask equipped with a condenser. After three cycles of freeze-pump-thaw, the mixture was protected with nitrogen and reflux at 80° C. for 16 h. The reaction was quenched by cooling down to room temperature and precipitating the polymer in methanol. In another batch, methyl methacrylate was used instead of n-butyl acrylate. The same procedures were followed. Successful incorporation of PS macromonomer into PMMA or PBA backbone is proved by disappearance of the vinyl proton peak at 5.77 ppm in copolymer ¹H-NMR spectra, as shown in FIGS. 18 and 19. The average number molecular weight and PDI of PMMA-g-PS were 73.4 k and 1.57. The GPC trace of PMMA-g-PS is shown in FIG. 20A. The average number molecular weight and PDI of PBA-g-PS were 198 k and 1.48. The GPC trace of PBA-g-PS is shown in FIG. 20B.

It will be understood that various details of the presently disclosed subject matter may be changed without departing from the scope of the presently disclosed subject matter. Furthermore, the foregoing description is for the purpose of illustration only, and not for the purpose of limitation.

1. A method of preparing a macromonomer, wherein said macromonomer comprises one or more polymeric chains attached to a polymerizable group, the method comprising:
(a) polymerizing at least a first monomer via radical polymerization to form a reactive group-terminated polymeric chain, wherein said reactive group-terminated polymeric chain comprises a polymer chain having a terminal reactive group at one end, wherein said terminal reactive group comprises a hydroxyl group or an amino group; and
(b) contacting said reactive group-terminated polymeric chain with a difunctional compound comprising a polymerizable group and at least one carboxylic acid group or derivative thereof, thereby forming a covalent bond between the terminal reactive group of the reactive group-terminated polymeric chain and the at least one carboxylic acid group or derivative thereof of the difunctional compound.

2. The method of claim 1, wherein the first monomer comprises a vinyl group.

3. The method of claim 1, wherein the first monomer is selected from the group consisting of a styrene, α-methyl styrene, ethene, propene, vinyl chloride, vinyl pyridine, methyl methacrylate, acrylonitrile, and cyclohexadiene.

4. The method of claim 1, wherein the polymerizing of step (a) comprises contacting the first monomer with a radical initiator and a chain transfer agent.

5. The method of claim 4, wherein the radical initiator is 4,4′-azobis(4-cyano-1-pentanol), azobisisobutyronitrile (AIBN), or hydrogen peroxide.

6. The method of claim 5, wherein the radical initiator is AIBN, the reactive terminal group is an amino group, and step (a) further comprises reducing a cyano group to form the amino group.

7. The method of claim 4, wherein the chain transfer agent comprises a mercapto group, optionally wherein the chain transfer agent is dodecyl mercaptan.

8. The method of claim 1, wherein the polymerizing of step (a) is performed in an emulsion comprising the first monomer and a radical initiator.

9. The method of claim 1, wherein the polymerizing of step (a) comprises: (i) contacting the at least first monomer and a chain transfer agent with an aqueous solution comprising a surfactant to form an emulsion; and (ii) adding a solution comprising a radical initiator in an aprotic solvent to the emulsion.

10. The method of claim 9, wherein the surfactant is sodium dodecylbenzenesulfonate (SDBS).

11. The method of claim 9, wherein the aprotic solvent is tetrahydrofuran (THF).

12. The method of claim 1, wherein the polymerizable group is a carbon-carbon double bond.

13. The method of claim 1, wherein the difunctional compound is a monocarboxylic acid or derivative thereof or is a dicarboxylic acid or derivative thereof.

14. The method of claim 1, wherein the difunctional compound is selected from the group consisting of 4-vinyl benzoic acid, maleic anhydride, fumaric acid, fumaric acid chloride, maleic acid chloride, and maleic acid.

15. The method of claim 1, wherein the difunctional compound is a dicarboxylic acid or acid derivative and the macromonomer comprises two polymeric chains attached to a polymerizable functional group.

16. The method of claim 1, wherein the contacting of step (b) comprises contacting the difunctional compound and the reactive group-terminated polymeric chain with a carbodiimide, optionally dicyclohexylcarbodiimide (DCC), and a nucleophilic catalyst, optionally dimethylaminopyridine (DMAP), in an aprotic organic solvent, optionally tetrahydrofuran (THF) or dichloromethane (DCM).

17. The method of claim 1, wherein the difunctional compound is maleic anhydride or maleic acid, and the method provides a macromonomer comprising two polymeric chains attached to a polymerizable functional group.

18. The method of claim 1, wherein the macromonomer has a number average molecular mass (Mₙ) of at least about 3,000 g/mol.

19. The method of claim 1, wherein the macromonomer has a polydispersity index (PDI) of between about 1.5 and about 4.0.

20. A method of preparing a multigraft copolymer, said method comprising:
(a) preparing a macromonomer via radical polymerization, wherein said macromonomer comprises one or more polymeric chains attached to a polymerizable group, and wherein the one or more polymeric chains comprise constitutional units from at least a first monomer;
(b) contacting the macromonomer with at least a second monomer; and
(c) copolymerizing the macromonomer and the second monomer to form a multigraft copolymer.

21. The method of claim 20, wherein the first monomer comprises a vinyl group.

22. The method of claim 20, wherein the polymerizable group is a carbon-carbon double bond.

23. The method of claim 20, wherein the first monomer is selected from the group consisting of a styrene, α-methyl styrene, ethene, propene, vinyl chloride, vinyl pyridine, methyl methacrylate, acrylonitrile, and cyclohexadiene.

24. The method of claim 20, wherein preparing the macromonomer comprises contacting the at least first monomer with a radical initiator and a chain transfer agent to provide a reactive group-terminated polymeric chain comprising constitutional units from the first monomer and a terminal reactive group at one end comprising a hydroxyl group or an amino group.

25. The method of claim 24, wherein the radical initiator is 4,4′-azobis(4-cyano-1-pentanol), azobisisobutyronitrile (AIBN), or hydrogen peroxide.

26. The method of claim 24, wherein the chain transfer agent comprises a mercaptan, optionally wherein the chain transfer agent is dodecyl mercaptan.

27. The method of claim 24, wherein the contacting of the first monomer, radical initiator and the chain transfer agent is performed in an emulsion, wherein said emulsion comprises water, a surfactant, and an aprotic solvent.

28. The method of claim 20, wherein preparing the macromonomer comprises contacting a reactive group-terminated polymeric chain comprising constitutional units from the first monomer with a difunctional compound comprising a polymerizable group and a carboxylic acid group or a derivative thereof.

29. The method of claim 28, wherein the carboxylic acid group or derivative thereof is a carboxylic acid, an acyl chloride, or an anhydride.

30. The method of claim 28, wherein the difunctional compound is a monocarboxylic acid or acid derivative or a dicarboxylic acid or acid derivative.

31. The method of claim 28, wherein the difunctional compound is selected from the group consisting of 4-vinyl benzoic acid, maleic anhydride, fumaric acid, fumaric acid chloride, maleic acid chloride, and maleic acid.

32. The method of claim 28, wherein the difunctional compound is a dicarboxylic acid or acid derivative and the macromonomer is a double-chain macromonomer.

33. The method of claim 20, wherein the at least second monomer is an alkene, optionally wherein the second monomer is isoprene, butadiene, an alkyl acrylate, or n-butyl acrylate.

34. The method of claim 20, wherein the copolymerizing of step (c) comprises radical polymerization.

35. The method of claim 20, wherein the copolymerizing of step (c) is performed in an emulsion.

36. The method of claim 20, wherein the macromonomer has a number average molecular mass (Mₙ) of at least about 3,000 g/mol.

37. The method of claim 20, wherein the multigraft copolymer has a number average molecular mass (Mₙ) of at least about 50,000 g/mol.

38. The method of claim 20, wherein the multigraft copolymer has a centipede architecture.

39. The method of claim 20, wherein the first monomer is styrene and the second monomer is isoprene.

40. A multigraft copolymer prepared by the method of claim 20.

41. The multigraft copolymer of claim 40, wherein said multigraft copolymer comprises a rubbery polymeric main chain and a plurality of glassy or semi-crystalline polymeric side chains, wherein the polymeric main chain comprises a plurality of randomly spaced branch points, and wherein each of the plurality of glassy or semi-crystalline polymeric side chains is attached to the main chain at one of the plurality of randomly spaced branch points.

42. The multigraft copolymer of claim 40, wherein the first monomer is styrene and the glassy or semi-crystalline polymeric side chains comprise polystyrene.

43. The multigraft copolymer of claim 40, wherein the second monomer is isoprene and the rubbery polymeric main chain comprises polyisoprene.

44. A thermoplastic elastomer comprising the multigraft copolymer of claim 40.

45. An adhesive comprising the multigraft copolymer of claim 40.
